(19) United States
(12) Patent Application Publication
(10) Pub. No.: US 2026/0250995 A1
(43) Pub. Date: Aug. 27, 2026

(54) FLUSH BOLT

(71) Applicant: QINGDAO SEA NOVA BUILDING PROFILES PRODUCTS CO., LTD., JIAOZHOU (CN)

(72) Inventors: Jianxun ZHANG, JIAOZHOU CITY (CN); James William Meeks, EATON, OH (US); Yi CAO, JIAOZHOU (CN); Xuhui WU, JIAOZHOU (CN)

(21) Appl. No.: 19/418,984

(22) Filed: Dec. 13, 2025

(30) Foreign Application Priority Data
Feb. 21, 2025 (CN) 202510194667.8
Nov. 18, 2025 (CN) 202511692773.5

(51) Int. Cl. E05C 1/14

(52) U.S. Cl. CPC E05C 1/145

(57) ABSTRACT

A flush bolt configured to be installed on a door leaf with an astragal. The flush bolt comprises a main body, a bolt and an actuating mechanism. The main body includes a chassis, a faceplate fixed to the chassis and a backplate. The faceplate is divided by a hypothetical plane which is perpendicular to the faceplate and which passes through an axis of the bolt into a first flange and a second flange. The first flange and the second flange are fixedly attached to the chassis. The backplate is divided by a hypothetical plane which is perpendicular to the backplate and which passes through an axis of the bolt into a third flange and a fourth flange. The third flange includes a first pair of fixed sections and a first movable section that is separate from the first pair of fixed sections.

### RELATED APPLICATIONS

The application claims the benefit of CN202510194667.8 filed February 21, 2025 and CN202511692773.5 filed November 18, 2025, each of which is incorporated herein by reference in its entirety.

### FIELD OF THE INVENTION

The invention, which is related to a flush bolt that features a variety of mechanisms for strengthening the connection between the flush bolt and the doors, belongs to the technical field of door and window hardware accessories.

### BACKGROUND OF THE INVENTION

In door and window systems, a flush bolt plays multiple crucial roles. From a safety perspective, the flush bolt prevents doors and windows from being accidentally pushed or pried open, for indoor safety. Functionally, a flush bolt fixes the position of doors and windows, prevents doors and the windows from shaking due to external forces from, for example, strong winds. In terms of ease of use, the flush bolt is simple to operate, allowing a user to easily open and close doors and windows.

As a core locking component in structures such as doors, windows, and cabinets, the flush bolt is designed to reliably lock and easily unlock an entrance. The flush bolt ensures the safety of people and goods and improves the airtightness of spaces. Also, the flush bolt indirectly extends the overall service life of doors, windows, and cabinets by stabilizing the relative positions of components and preventing wear and tear or structural deformation caused by long-term shaking. Thus, the flush bolt is an indispensable key component in door and window systems.

Specifically, the flush bolt prevents parts from being opened accidentally. Risk from children accidentally opening the windows or items falling from cabinets due to loose doors is reduced. The flush bolt locks tightly and reduces gaps between parts. The flus bolt reduces intrusion of wind, rain, dust and noise transmission to improve spatial comfort. At the same time, the stabilizing and limiting function of a flush bolt reduces the likelihood of structural deformation and extends the overall service life of windows and doors.

However, the flush bolt in the prior art suffers technical defects that seriously affect the performance and reliability of the product. During the operation of a flush bolt, axial tension or circumferential rotation is easily generated, leading to deviation during extension and retraction, inaccurate positioning or even functional failure. The screw holes are so placed such that the flush bolt is primarily connected to the door leaf but is not directly and rigidly fixed to the astragal being mounted to the door lead. The consequences include insufficient connection strength, weak resistance to wind pressure and easy loosening after repeated opening and closing. The overall stability and service life of the door and window is significantly reduced.

To address some of the above issues, existing technologies have proposed related improvement schemes. But there are still obvious shortcomings. For example, Chinese patent application CN103851050A disclosed on June 11, 2014 a flush bolt that adopts a compression spring on the movable pin, using the spring force to press the positioning pin against the guide component and engage it in the positioning slot, thereby locking the movable pin in the extended and retracted positions. This initially alleviates the problem of the flush bolt whose function of automatic extension and retraction is prone to failure. However, this scheme still fails to solve the direct connection issue between the bolt and the moving rod. Nor the connection strength and wind resistance performance have been improved. Additionally, relying solely on the spring limit structure requires considerable operational force during extension and retraction, which can easily lead to spring deformation and makes it difficult to achieve precise positioning and smooth operation reliably. At the same time, the flush bolt still experiences deviation caused by circumferential rotation during use, and the single operational method also limits its adaptability.

In summary, although existing technologies have made improvements to certain defects of traditional flush bolts. They cannot address the issues such as limited operation methods leading to narrow adaptability, spring limiter structures being prone to deformation affecting telescopic stability and pin circumferential rotation causing positioning errors. Therefore, an improved flush bolt is needed to resolve the above technical shortcomings.

### OBJECTS AND SUMMARY OF THE INVENTION

Therefore, it is an object of the claimed invention to provide a significantly improved flush bolt.

A flush bolt is provided to be installed on a door leaf with an astragal. The flush bolt comprises a main body, a bolt and an actuating mechanism. The astragal is mounted to an edge of the door leaf. The main body houses the actuating mechanism and at least a portion of the bolt. The actuating mechanism is configured to extend and retract the bolt. The main body includes a chassis, a faceplate fixed to the chassis and a backplate. The faceplate is configured to lie flush with an edge of the astragal. The chassis provides a framework onto which the actuating mechanism and the bolt are operably assembled. The chassis includes a portal through which the bolt can protrude from the main body and slide back and forth. The chassis, which is sandwiched between the faceplate and the backplate, is encased with the faceplate and the backplate. The bolt includes a stub on one end and a tip on an other end. The actuating mechanism includes a lever and an articulated arm. The articulated arm includes a first section and a second section that pivotably joins the first section. The stub is slidably plugged into a socket in the second section of the articulated arm. The socket and the stub are configured such that the stub is permitted to slide back and forth in the socket but is not permitted to spin or move otherwise in the socket. The bolt further includes on the stub a neck that slidably sticks into a slot on the second section of the articulated arm to guide a travel of the bolt when the bolt is being extended or retracted. The first section is pivotably connected to the lever at one end and pivotably connected to the second section at an other end. The second section is pivotably connected to the first section at one end and slidably connected to the bolt at an other end. The lever, which is configured to pivot around a shaft fixed on the chassis, has a first position and a second position. A force applied to rotate the lever, which is transferred to the articulated arm, can slide the second section back and forth within the main body. The bolt is configured to be fully retracted by the articulated arm when the lever is manipulated to the first position. The bolt is configured to be fully extended by the articulated arm when the lever is manipulated to the second position. The faceplate is divided by a hypothetical plane which is perpendicular to the faceplate and which passes through an axis of the bolt into a first flange and a second flange. The first flange and the second flange are fixedly attached to the chassis. The first flange and the second flange always stay fixed on the chassis when the bolt is moving. The faceplate includes an opening to allow an external force to be applied to the lever. The backplate is divided by a hypothetical plane which is perpendicular to the backplate and which passes through an axis of the bolt into a third flange and a fourth flange. The third flange includes a first pair of fixed sections and a first movable section that is separate from the first pair of fixed sections. The first movable section is fixedly connected to the bolt at the neck. The first pair of fixed sections are fixedly attached to the chassis. The first movable section is configured to slide over the chassis when the bolt is being extended or retracted while the first pair of fixed sections always stay fixed on the chassis. A length of the backplate, along a direction parallel to an axis of the bolt, is A. A combined length of the first pair of fixed sections, along a direction parallel to an axis of the bolt, is B1. A length of the first movable section, along a direction parallel to an axis of the bolt, is C1. A length of a portion of the bolt that sticks out of the main body, along a direction parallel to an axis of the bolt, is D when the lever stays at the second position. The tip is configured to slide into a hole to lock the door leaf when the actuating mechanism extends the bolt until the neck arrives at a first end of the slot. The tip is configured to slide out of the hole to unlock the door leaf when the actuating mechanism retracts the bolt until the neck arrives at a second end of the slot. A distance between the first end of the slot and the second end of the slot is L. The flush bolt is configured such that (A–B1–C1) ≥ L and L ≥ D.

A length of the first movable section is longer, along a direction parallel to an axis of the bolt, than a length of any one of the first pair of fixed sections. The second section further includes a spring in the socket to cushion a slidable connection between the second section and the bolt. The bolt when being extended can be pushed back into the main body by overcoming a load of the spring with an external force. An entire tip of a fully extended bolt, when being pushed with an external force, can recede into the main body by compressing the spring while the lever is staying at the second position. The bolt being pushed into the main body is configured to bounce back to an extended position when the bolt is released. The faceplate and the backplate are parallel to an axis of the bolt. The lever includes a bearing which is configured to pivot around the shaft. The bearing includes a first flat section, a second flat section and a transition that connects the first flat section and the second flat section. The actuation mechanism further includes a flat spring which biases the lever against the shaft. The transition is configured such that the lever will be destabilized by the flat spring when the bearing is abutting the flat spring with the transition. The flat spring is configured to urge the lever that is teetering between the first position and the second position to, in response to a gentle nudge upon the lever, rest either at the first position or at the second position. The bolt further includes an extension rod to interconnect the stub and the tip. A cross section of the stub defines a first rectangle. A cross section of an internal wall of the socket that receives the stub defines a second rectangle with a slightly greater dimension than the first rectangle. One or both of the tip and the extension rod are cylindrical. A cross section of the stub is rectangular. A length of the first movable section is longer, along a direction parallel to an axis of the bolt, than a combined length of the first pair of fixed sections. The first section of the articulated arm is angled to pivotably connect the lever and to pivotably connect the second section of the articulated arm. A portion of the lever which is not at the second position sticks out of the opening on the faceplate to await a first force. The lever which is not at the second position can be manipulated to the second position when the portion of the lever receives the first force. The lever at the second position is configured to lie flush with the faceplate to await a second force which is opposite to the first force. The lever which is not at the first position can be manipulated to the first position when the lever receives the second force.

The fourth flange includes a fixed section which is fixedly attached to the chassis but no movable section. The fourth flange always stay fixed to the chassis. A length of the fourth flange along a direction parallel to an axis of the bolt is E. The flush bolt is configured such that (E–B1–C1) ≥ L. The first flange and the second flange are configured to lie flush with an edge of the astragal. The first pair of fixed sections and the fourth flange are configured to be fixedly embedded into a mortise carved in the astragal such that the first pair of fixed sections and the fourth flange sit flush with an interface between the door leaf and the astragal. The faceplate includes a plurality of holes on both sides of the opening. The backplate includes a plurality of holes on the first the pair of fixed sections and on the four flange. The flush bolt is configured to allow screws to be driven through the plurality of holes on the faceplate, to penetrate the astragal, to pass through the plurality of holes on the backplate and to bite into the door leaf for the flush bolt to attach tightly to the astragal and door leaf. The flush bolt is configured to allow heads of the screws to sit flush with an edge of the astragal. The first movable section is configured to slide, when the bolt is moving, with a clearance fit in a passageway defined by a mortise in the astragal and an edge of the door leaf.

Alternatively, the fourth flange includes a second pair of fixed sections and a second movable section that is separate from the second pair of fixed sections. The second movable section is fixedly connected to the bolt at the neck. The second pair of fixed sections are fixedly attached to the chassis. The second movable section is configured to slide over the chassis when the bolt is being extended or retracted while the second pair of fixed sections always stay fixed on the chassis. A combined length of the second pair of fixed sections, along a direction parallel to an axis of the bolt, is B2. A length of the second movable section, along a direction parallel to an axis of the bolt, is C2. The flush bolt is configured such that (A–B2–C2) ≥ L. The third flange and the fourth flange are symmetric with respect to the hypothetical plane that divides the backplate. The first movable section and the second movable section move together with the bolt when the bolt is movable while the first pair of fixed sections and the second pair of fixed sections always stay fixed on the chassis. The first movable section is configured to slide between the first pair of fixed sections. The first movable section abuts a first one of the first pair of fixed sections but is spaced apart from a second one of the first pair of fixed sections when the lever stays at the second position. The first movable section abuts the second one of the first pair of fixed sections but is spaced apart from the first one of the first pair of fixed sections when the lever stays at the first position. The second movable section is configured to slide between the second pair of fixed sections. The second movable section abuts a first one of the second pair of fixed sections but is spaced apart from a second one of the second pair of fixed sections when the lever stays at the second position. The second movable section abuts the second one of the second pair of fixed sections but is spaced apart from the first one of the second pair of fixed sections when the lever stays at the first position. A length of the first movable section is shorter, along a direction parallel to an axis of the bolt, than a length of one of the first pair of fixed sections. A length of the second movable section is shorter, along a direction parallel to an axis of the bolt, than a length of one of the second pair of fixed sections. The first movable section and the second movable section form a pair of wings that extend perpendicular to an axis of the bolt. The first flange and the second flange are configured to lie flush with an edge of the astragal. The first pair of fixed sections and the second pair of fixed sections are configured to be fixedly embedded into a mortise carved in the astragal such that the first pair of fixed sections and the second pair of fixed sections sit flush with an interface between the door leaf and the astragal. The faceplate includes a plurality of holes on both sides of the opening. The backplate includes a plurality of holes on the first pair of fixed sections and on the second pair of fixed sections. The flush bolt is configured to allow screws to be driven through the plurality of holes on the faceplate, to penetrate the astragal, to pass through the plurality of holes on the backplate and to bite into the door leaf for the flush bolt to attach tightly to the astragal and door leaf. The flush bolt is configured to allow heads of the screws to sit flush with an edge of the astragal. The first movable section and the second movable section are configured to slide, when the bolt is moving, with a clearance fit in a passageway defined by a mortise in the astragal and an edge of the door leaf.

Various other objects, advantages and features of the present invention will become readily apparent from the ensuing detailed description, and the novel features will be particularly pointed out in the appended claims.

### BRIEF DESCRIPTION OF FIGURES

The following detailed descriptions, given by way of example, and not intended to limit the present invention solely thereto, will be best be understood in conjunction with the accompanying figures:

FIG. 1 is a front view of an example of the double doors on which the flush bolt in the present invention is installed;

FIG. 2 is a perspective view of the first embodiment of the flush bolt in the present invention;

FIG. 3 is another perspective view of the flush bolt in FIG. 2;

FIG. 4 is a cross-sectional view of the flush bolt in FIG. 2 cut along A-A ;

FIG. 5 is a perspective view of a part of the flush bolt in FIG. 2 which highlights the lever that pivots around the shaft;

FIG. 6 is a perspective view of another part of the flush bolt in FIG. 2 which highlights the connection between the second section of the articulated arm and the bolt;

FIG. 7 is a cross-sectional view, cut along B-B, of the flush bolt in FIG. 2 when the flush bolt is installed on the astragal and the inactive door leaf in FIG. 1;

FIG. 8 is a perspective view of the second embodiment of the flush bolt in the present invention;

FIG. 9 is another perspective view of the flush bolt in FIG. 8;

FIG. 10 is a top view of the flush bolt in FIG. 8;

FIG. 11 is a sectional view of the flush bolt in FIG. 10 cut along B-B;

FIG. 12 is a sectional view of the flush bolt in FIG. 10 cut along A-A;

FIG. 13 is an exploded view of a part of the flush bolt in FIG. 8 where the bolt is disconnected from the second section of the articulated arm in order to show how the parts fit together;

FIG. 14 is another exploded view of the part of the flush bolt in FIG. 13;

FIG. 15 is a cross-sectional view of the flush bolt in FIG. 10 cut along B-B when the bolt is fully extended;

FIG. 16 is cross-sectional view of the flush bolt in FIG. 10 cut along B-B, except that the bolt is partially extended;

FIG. 17 is cross-sectional view of the flush bolt in FIG. 10 cut along B-B, except that the bolt is fully retracted;

FIG. 18 is a cross-sectional view of the flush bolt in FIG. 10 cut along A-A when the bolt is fully extended;

FIG. 19 is a cross-sectional view of the flush bolt in FIG. 10 cut along A-A, except that the bolt is partially extended;

FIG. 20 is a cross-sectional view of the flush bolt in FIG. 10 cut along A-A, except that the bolt is fully retracted;

FIG. 21 is a cross-sectional view, cut along C-C, of the flush bolt in FIG. 10 when the flush bolt is installed on the astragal and the inactive door leaf in FIG. 1;

FIG. 22 is a cross-sectional view, cut along D-D, of the flush bolt in FIG. 10 when the flush bolt is installed on the astragal and the inactive door leaf in FIG. 1;

FIG. 23 is a perspective view of the third embodiment of the flush bolt in the present invention;

FIG. 24 is another perspective view of the flush bolt in FIG. 23;

FIG. 25 is a top view of the flush bolt in FIG. 23;

FIG. 26 is a sectional view of the flush bolt in FIG. 25 cut along A-A;

FIG. 27 is a cross-sectional view of the flush bolt in FIG. 25 cut along A-A when the bolt is fully extended;

FIG. 28 is a cross-sectional view of the flush bolt in FIG. 25 cut along A-A, except that the bolt is partially extended;

FIG. 29 is a cross-sectional view of the flush bolt in FIG. 25 cut along A-A, except that the bolt is fully retracted;

FIG. 30 is an exploded view of a part of the flush bolt in FIG. 23 where the bolt is disconnected from the second section of the articulated arm in order to show how the parts fit together;

FIG. 31 is another exploded view of the part of the flush bolt in FIG. 30;

FIG. 32 is a cross-sectional view, cut along C-C, of the flush bolt in FIG. 25 when the flush bolt is installed on the astragal and the inactive door leaf in FIG. 1; and

FIG. 33 is a cross-sectional view, cut along D-D, of the flush bolt in FIG. 25 when the flush bolt is installed on the astragal and the inactive door leaf in FIG. 1.

### DETAILED DESCRIPTION OF THE EMBODIMENTS

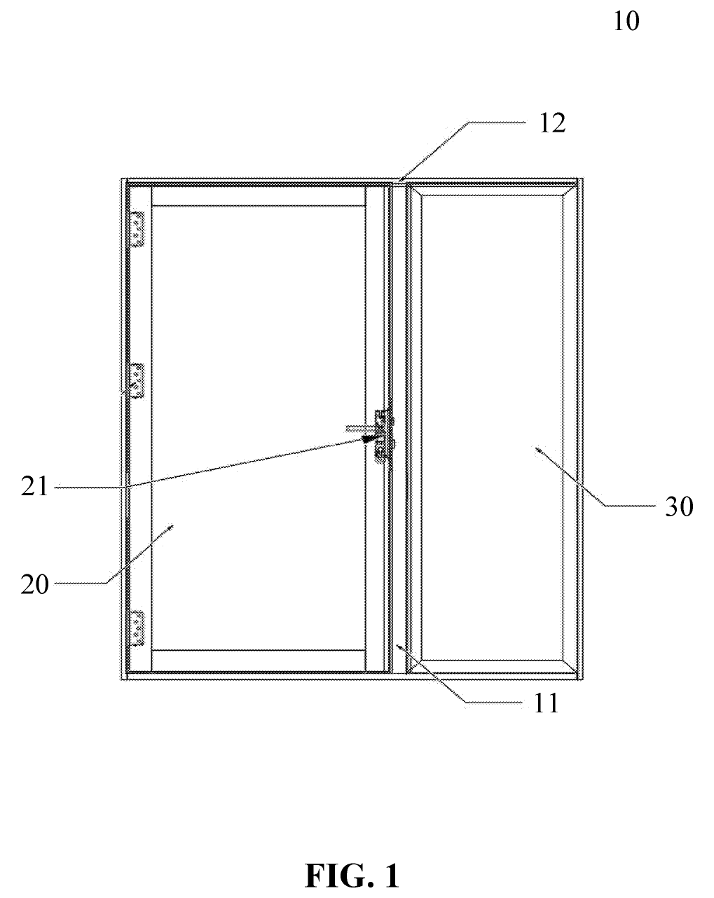

See FIG. 1 for an example of the double doors 10 often used at front entrances to buildings as well as for storage closets, conference room entrances and openings to other large spaces. The pair of doors 10 includes two door leaves 20, 30 in the frame 12. The active door leaf 20 on the double doors 10 has a lockset 21 while the inactive door leaf 30 does not have keyed locking hardware on the outside. The inactive door leaf 30 usually cannot be opened unless the active door leaf 20 has been opened. On a pair of doors that goes into a storage room, for example, the inactive door leaf 30 has a flush bolt 100, 200, 300 installed that keeps the inactive door leaf 30 secure and which is only accessible when the active door leaf 20 is opened. This inactive door leaf 30 is usually left secured unless equipment or other large material needs to move through the opening. In an embodiment, an astragal 11 is mounted on the inactive door leaf 30 to seal the gap between the pair of door leaves 20, 30 when they are closed.

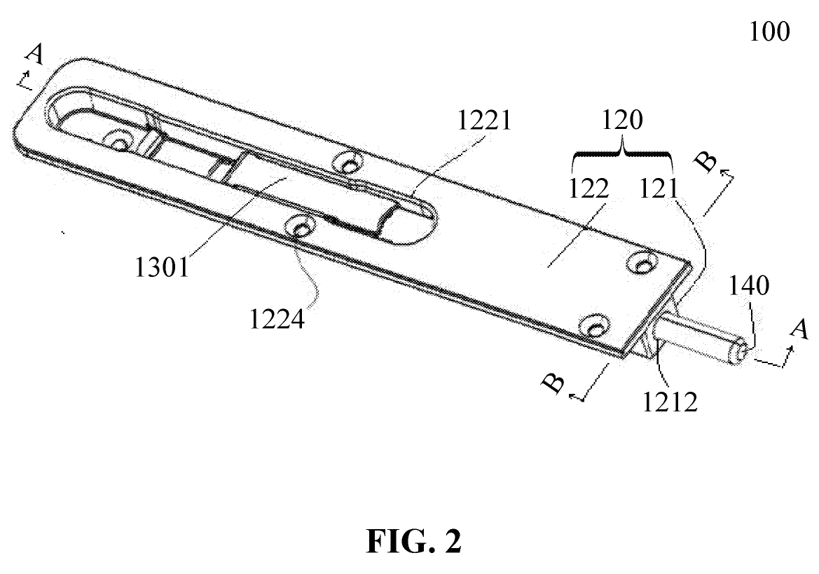

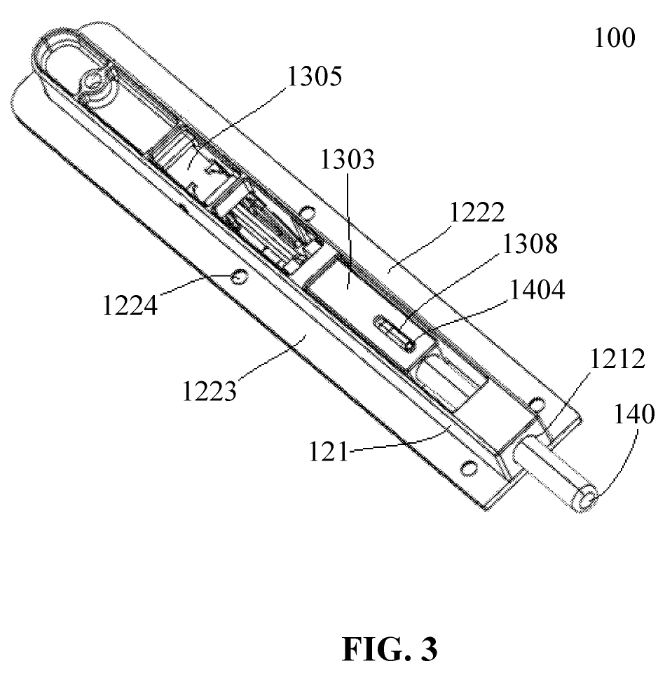

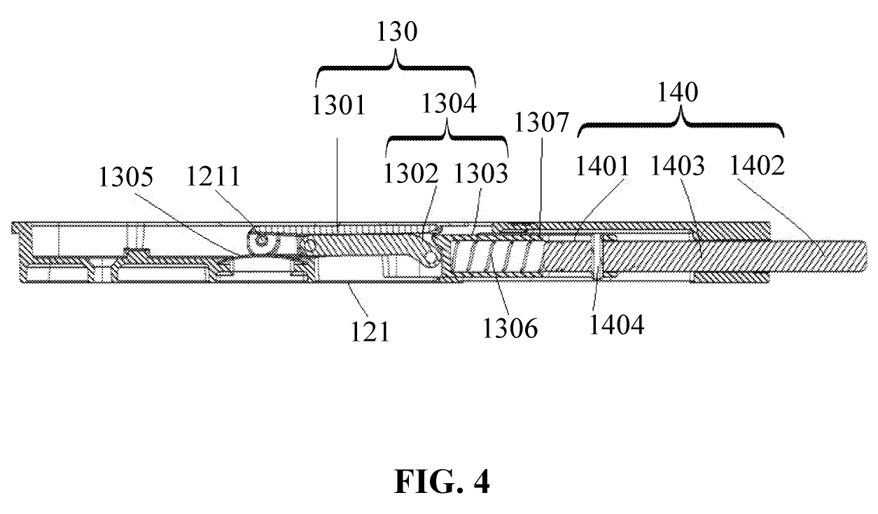

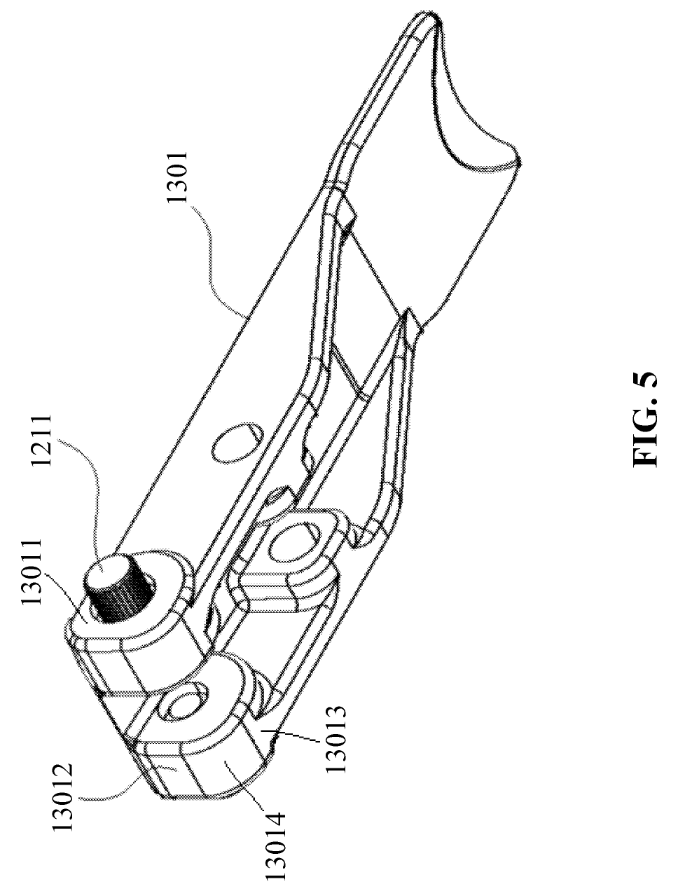

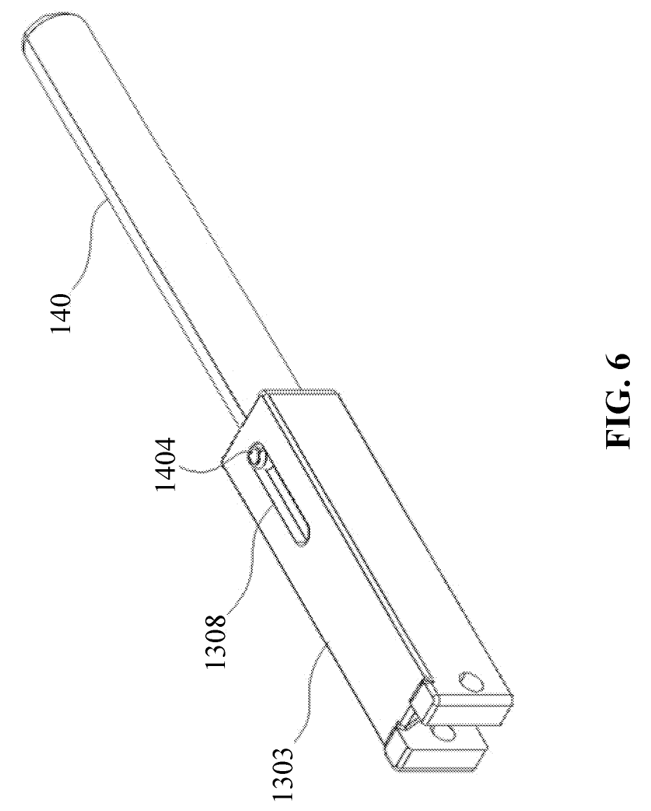

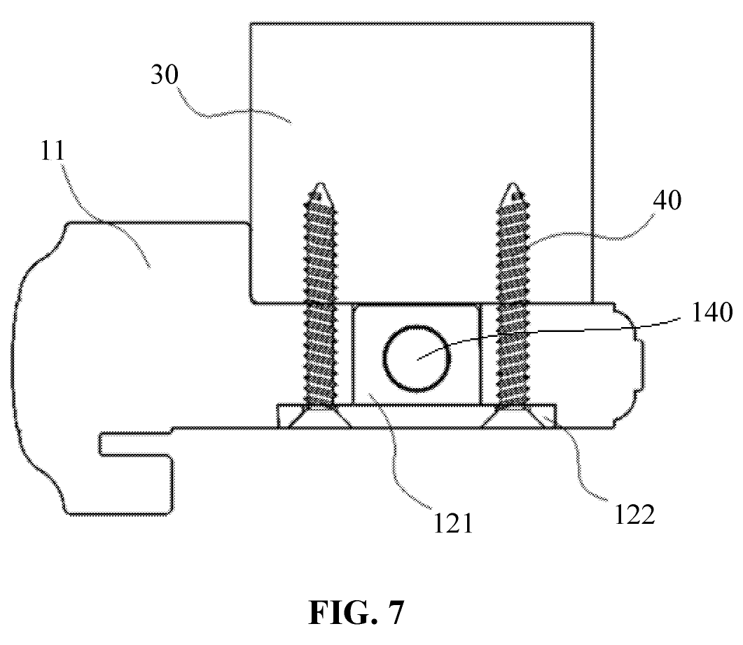

See FIGS. 2-7 for the first embodiment of our invention. The flush bolt 100 includes a main body 120, a bolt 140 and an actuating mechanism 130. The main body 120 houses the actuating mechanism 130 and at least a portion of the bolt 140. The actuating mechanism 130 is configured to extend and retract the bolt 140. In an embodiment, the flush bolt 100 is embedded into a mortise in the door leaf to sit flush with an edge of the door leaf. In another embodiment, the flush bolt 100 is embedded into a mortise in the astragal 11 to lie flush with an edge of the astragal 11 which is mounted on the edge of the door leaf 30. In an embodiment, the flush bolt 100 is installed at a top of the door leaf 30. A strike plate fits into a hole in the head jamb or the ceiling for the bolt 140 to slide in and out. In another embodiment, the flush bolt 100 is installed at a bottom of the door leaf 30. A strike plate fits into a hole in the floor or the threshold for the bolt 140 to slide in and out.

Stay on FIGS. 2-7. The main body 120 includes a chassis 121 and a faceplate 122 fixed to the chassis 121. The chassis 121 provides a framework onto which the actuating mechanism 130 and the bolt 140 are operably assembled. The chassis 121 includes a portal 1212 through which the bolt 140 can protrude from the main body 120 and slide back and forth. In an embodiment, the bolt 140 can withdraw completely into the main body 120 through the portal 1212. In an embodiment, the faceplate 122 should sit flush with an edge of the door leaf when the flush bolt 100 is properly installed. In another embodiment, the faceplate 122 should lie flush with an edge of the astragal 11 which is mounted to an edge of the door leaf 30 when the flush bolt 100 is properly installed. The faceplate 122 includes an opening 1221 to allow an external force, which comes from a user or the active door leaf 20, to apply to the actuating mechanism 130. In an embodiment, the faceplate 122 is parallel to an axis of the bolt 140.

Still stay on FIGS. 2-7. The bolt 140 includes a stub 1401 on one end and a tip 1042 on the other end. In an embodiment, the bolt 140 further includes an extension rod 1403 to interconnect the stub 1401 and the tip 1402. The bolt 140 is connected, with a clearance fit, to the actuating mechanism 130 at the stub 1401. In an embodiment, the bolt 140 further includes on the stub 1401 a neck 1404 that slidably sticks into a slot 1308 on the actuating mechanism 130 to guide or regulate the travel of the bolt 140 when the bolt 140 is being extended or retracted. In an embodiment, the tip 1402 will slide into a hole in the strike plate when the actuating mechanism 130 extends the bolt 140 until the neck 1404 arrives at a first end of the slot 1308. In another embodiment, the tip 1402 will slide out of the hole in the strike plate when the actuating mechanism 130 retracts the bolt 140 until the neck 1404 arrives at a second end of the slot 1308. In an embodiment, the tip 1402 has beveled corners to prevent binding. In another embodiment, the tip 1402 has flat sides to prevent rotation.

Still stay on FIGS. 2-7. The actuating mechanism 130 includes a lever 1301 and an articulated arm 1304. The articulated arm 1304 includes a first section 1302 and a second section 1303 that pivotably joins the first section 1302. The first section 1302 is pivotably connected to the lever 1301 at one end and pivotably connected to the second section 1303 at the other end. In an embodiment, the first section 1302 is angled to pivotably connect the lever 1301 and the second section 1303. The second section 1303 is pivotably connected to the first section 1302 at one end and slidably connected to the bolt 140 at the other end. The lever 1301, which is configured to pivot around a shaft 1211 fixed on the chassis 121, has a first position and a second position. A force applied to rotate the lever 1301, which will be transferred to the articulated arm 1304, can slide the second section 1303 back and forth within the main body 120. The bolt 140 will be fully retracted by the articulated arm 1304 when the lever 1301 is manipulated to the first position. The bolt 140 will be fully extended by the articulated arm 1304 when the lever 1301 is manipulated to the second position (FIGS. 2-4). In an embodiment, a portion of the lever 1301 which is not at the second position sticks out of the opening 1221 on the faceplate 122 to await a first force. The lever 1301 which is not at the second position can be manipulated to the second position when the portion of the lever 1301 receives the first force. In another embodiment, the lever 1301 at the second position will lie flush with the faceplate 122 to await a second force which is opposite to the first force (FIGS. 2-4). The lever 1301 which is not at the first position can be manipulated to the first position when the lever 1301 receives the second force. In an embodiment, the lever 1301 includes a handle or a thumb turn. In another embodiment, the lever 1301 includes a plunger. In an embodiment, the lever 1301 includes a bearing 13011 which is configured to pivot around the shaft 1211. In an embodiment, the bearing 13011 includes a first flat section 13012, a second flat section 13013 and a transition 13014 that connects the first flat section 13012 and the second flat section 13013. In an embodiment, the actuation mechanism 130 further includes a flat spring 1305 which biases the bearing 13011 against the shaft 1211. The transition (e.g., an arced section) 13014 is configured such that the lever 1301 will be destabilized by the flat spring 1305 when the bearing 13011 is abutting the flat spring 1305 with the transition 13014. The flat spring 1305 is configured to urge the lever 1301 that is teetering between the first position and the second position (i.e., when the bearing 13011 is abutting the flat spring 1305 with the arched section; not shown in the drawings) to, in response to a gentle nudge upon the lever 1301, rest either at the first position (i.e., when the bearing 13011 is abutting the flat spring 1305 with the first flat section 13012; not shown in the drawings) or the second position (i.e., when the bearing 13011 is abutting the flat spring 1305 with the second flat section 13013; FIGS. 2-4). In an embodiment, the second section 1303 includes a slot 1308. The neck 1404 slidably sticks into the slot 1308 to guide or regulate the travel of the bolt 140 when the bolt 140 is being extended or retracted. In an embodiment, the second section 1303 further includes a socket 1307 into which the stub 1401 is slidably plugged into. In an embodiment, the second section 1303 includes a spring 1306 in the socket 1307 to cushion the slidable connection between the second section 1303 and the bolt 140. In an embodiment, the bolt 140 when being extended can be pushed back into the main body 120 by overcoming the load of the spring 1306 with an external force. In another embodiment, the entire tip 1402 of a fully extended bolt 140, when being pushed with an external force, can recede into the main body 120 by compressing the spring 1306 while the lever 1301 stays at the second position. The bolt 140 being pushing back into the main body 120 will bounce back to the extended position once the external force compressing the spring 1306 is removed.

Still stay on FIGS. 2-7. The chassis 121 is encased with the faceplate 122. In an embodiment, the faceplate 122 includes a first flange 1222 and a second flange 1223. The faceplate 122 is divided by a hypothetical plane which is perpendicular to the faceplate 122 and which passes through an axis of the bolt 140 into the first flange 1222 and the second flange 1223. In an embodiment, the first flange 1222 and the second flange 1223 are fixedly attached to the chassis 121. The first flange 1222 and the second flange 1223 always stay fixed on the chassis 121 when the bolt 140 is moving or not moving. In an embodiment, the first flange 1222 and the second flange 1223 will sit flush with an edge of the door leaf when the flush bolt 100 is properly installed. In another embodiment, the first flange 1222 and the second flange 1223 will sit flush with an edge of the astragal 11 that is mounted on an edge of the door leaf 30. In an embodiment, the faceplate 122 further includes an opening 1221 to allow access to the lever 1301 by a user or the active door leaf 20 that will rotate the lever 1301. In an embodiment, the first flange 1222 and the second flange 1223 are symmetrical with respect to the hypothetical plane. In another embodiment, the faceplate 122 includes a plurality of holes 1224 on both sides of the opening 1221. Screws 40 are driven through the plurality of holes 1224, penetrate the astragal 11 and bite into the door leaf 30 to fasten the flush bolt 100 tightly to the astragal 11 and door leaf 30. In an embodiment, the heads of the screws 40 sit flush with an edge of the astragal 11 when the flush bolt 100 is properly installed.

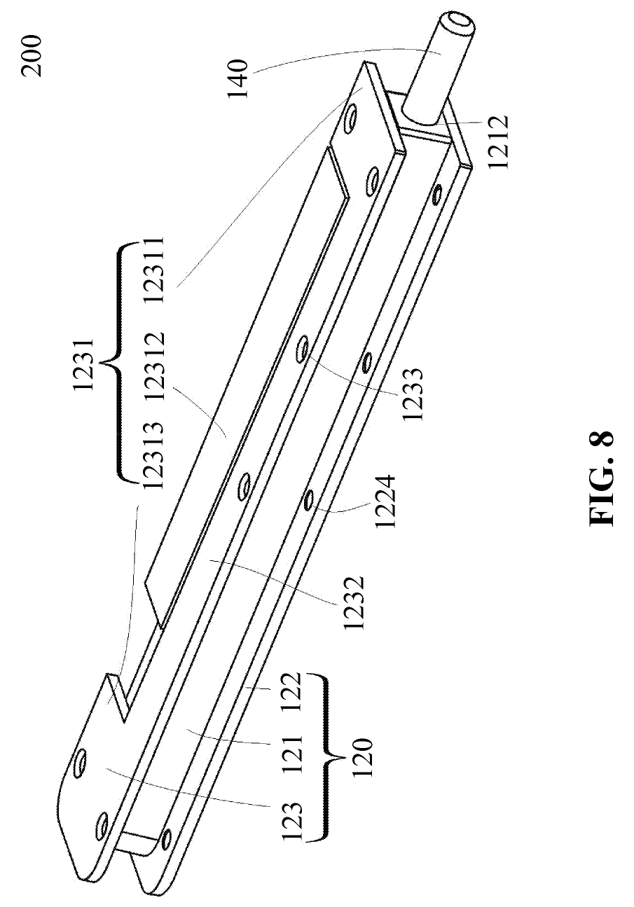

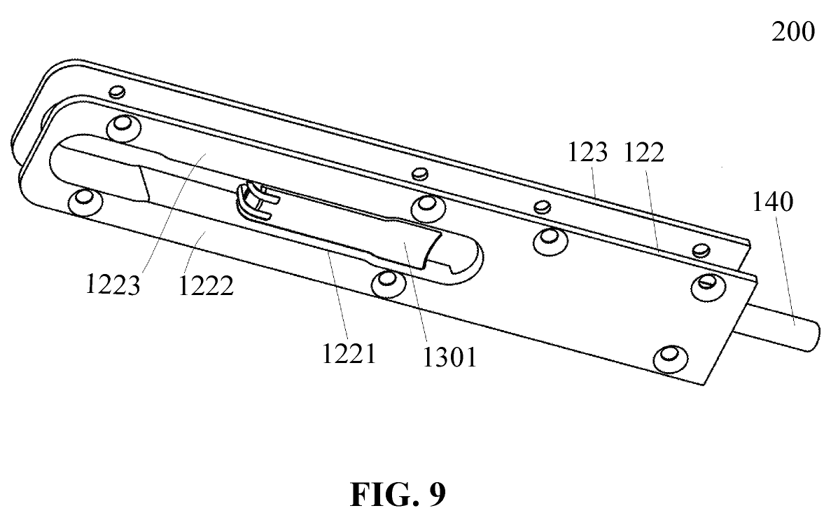

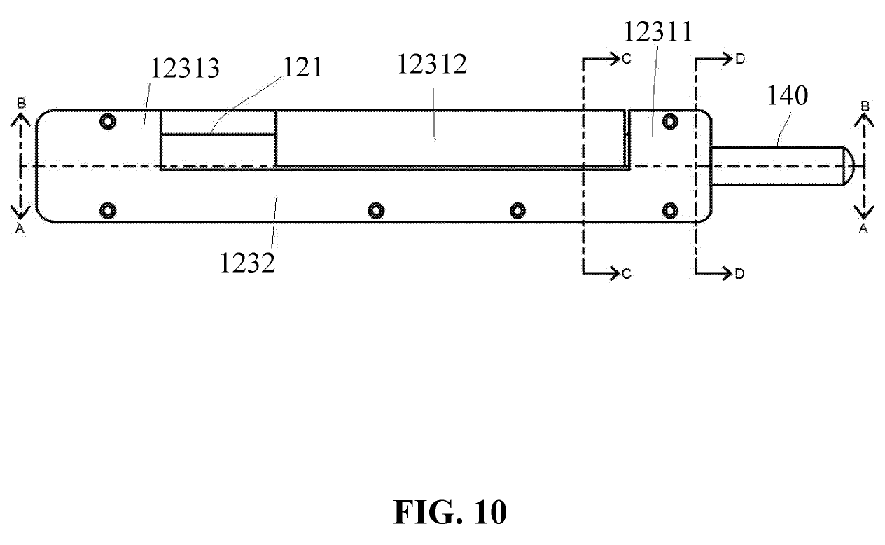

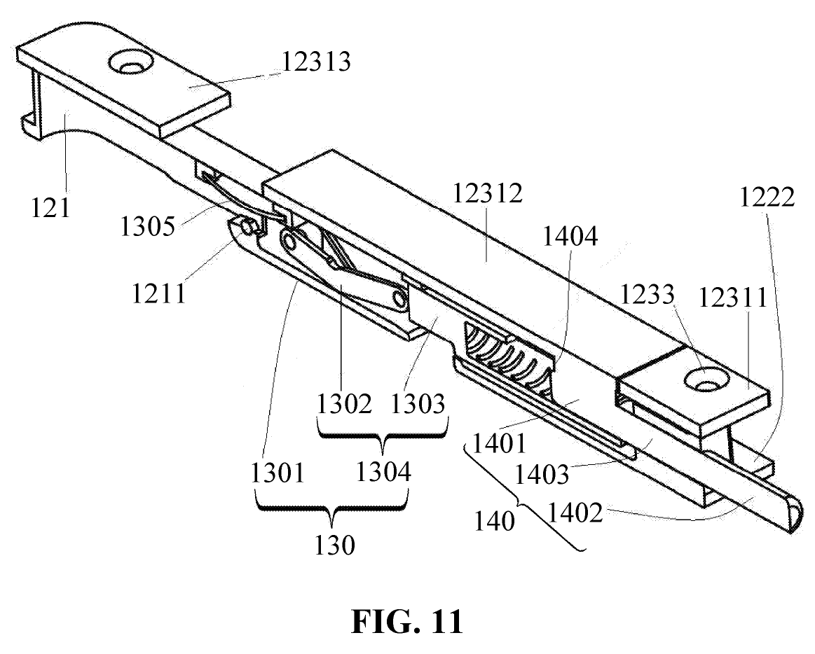

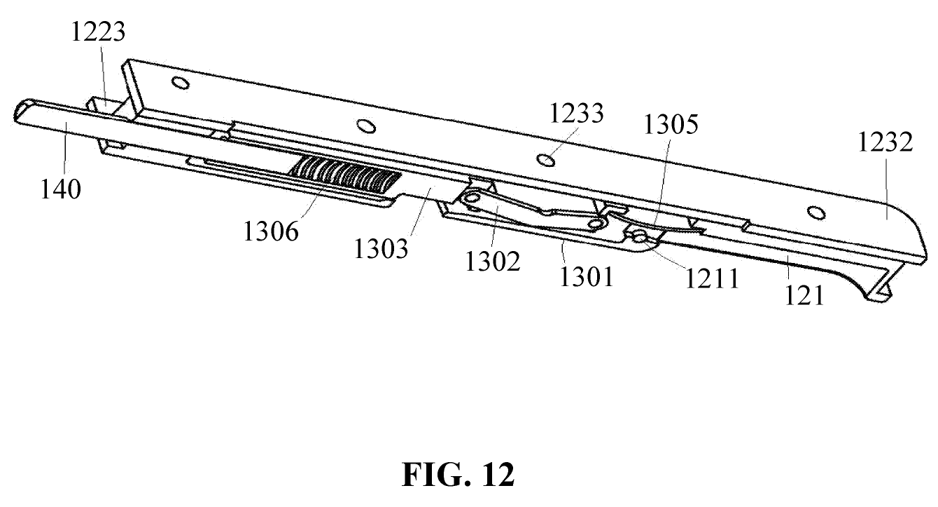

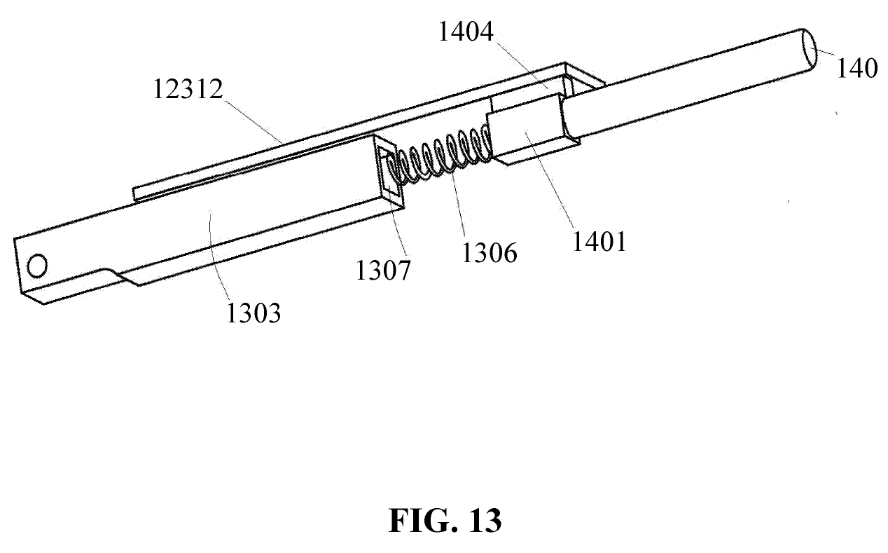

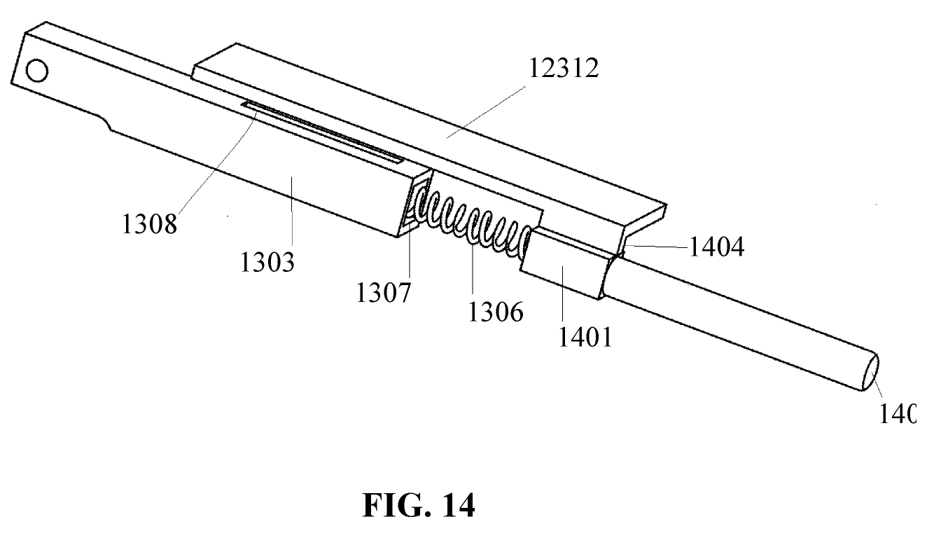

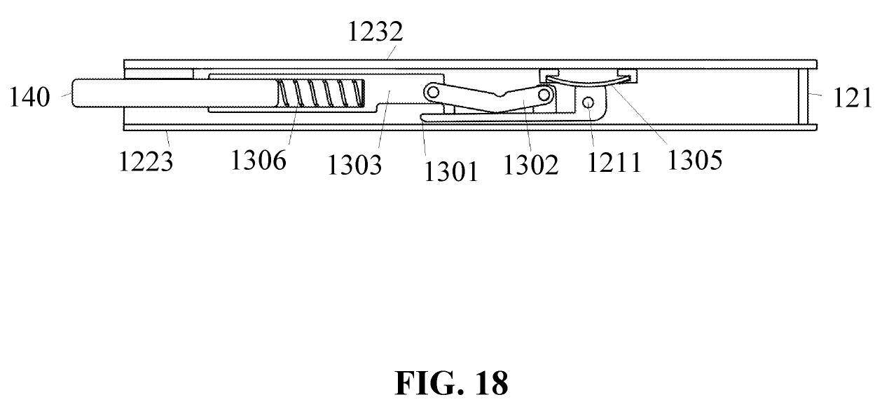

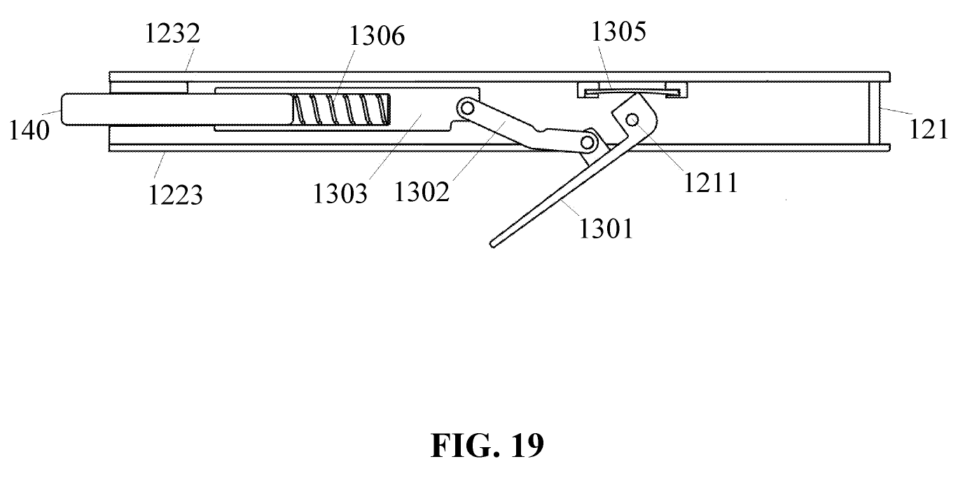

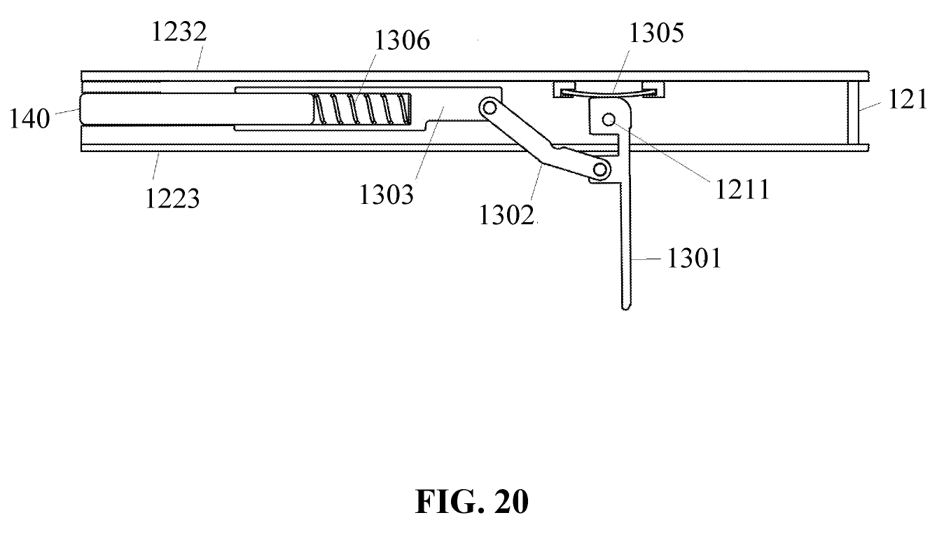

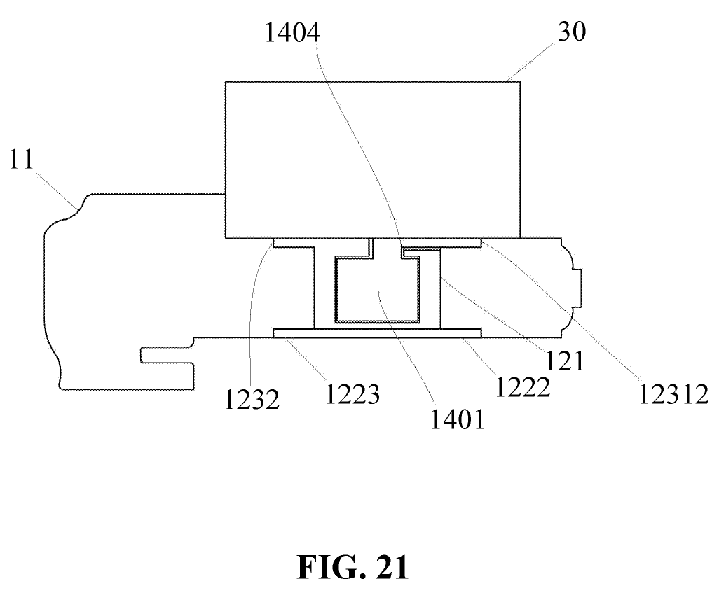

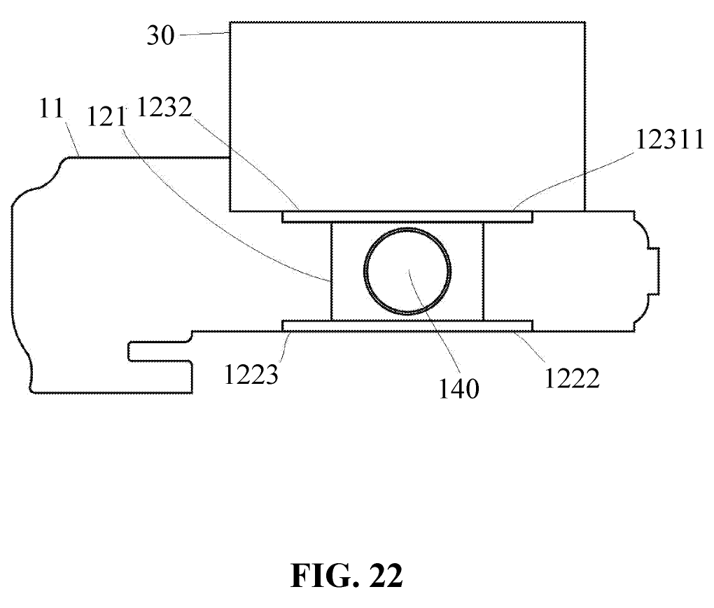

Shifting to FIGS. 8-22 for another embodiment of our invention. The flush bolt 200 includes a main body 120, a bolt 140 and an actuating mechanism 130. The main body 120 houses the actuating mechanism 130 and at least a portion of the bolt 140. The actuating mechanism 130 is configured to extend and retract the bolt 140. In an embodiment, the flush bolt 200 is embedded into a mortise in the door leaf to sit flush with an edge of the door leaf. In another embodiment, the flush bolt 200 is embedded into a mortise in the astragal 11 to lie flush with an edge of the astragal 11 which is mounted on an edge of the door leaf 30. In an embodiment, the flush bolt 200 is installed at a top of the door leaf 30. A strike plate fits into a hole in the head jamb or the ceiling for the bolt 140 to slide in and out. In another embodiment, the flush bolt 200 is installed at a bottom of the door leaf 30. A strike plate fits into a hole in the floor or the threshold for the bolt 140 to slide in and out.

Stay on FIGS. 8-22. The main body 120 includes a chassis 121, a faceplate 122 fixed to the chassis 121 and a backplate 123. The chassis 121 provides a framework onto which the actuating mechanism 130 and the bolt 140 are operably assembled. The chassis 121 includes a portal 1212 through which the bolt 140 can protrude from the main body 120 and slide back and forth. In an embodiment, the bolt 140 can withdraw completely into the main body 120 through the portal 1212. The faceplate 122 should sit flush with an edge of the door leaf when the flush bolt 200 is properly installed. In another embodiment, the faceplate 122 should lie flush with an edge of the astragal 11 which is mounted to an edge of the door leaf 30 when the flush bolt 200 is properly installed. The faceplate 122 includes an opening 1221 to allow an external force, which comes from a user or the active door leaf 20, to apply to the actuating mechanism 130. The chassis 121 is sandwiched between the faceplate 122 and the backplate 123. In an embodiment, the faceplate 122 is parallel to the backplate 123. In another embodiment, the faceplate 122 and the backplate 123 are parallel to the axis of the bolt 140.

Stay on FIGS. 8-22. The bolt 140 includes a stub 1401 on one end and a tip 1402 on the other end. In an embodiment, the bolt 140 further includes an extension rod 1403 to interconnect the stub 1401 and the tip 1402. The bolt 140 is connected, with a clearance fit, to the actuating mechanism 130 at the stub 1401. In an embodiment, the stub 1401 is slidably plugged into a socket 1307 on the actuating mechanism 130. In an embodiment, the stub 1401 is slidably plugged into a socket 1307 in the second section 1303 of the articulated arm 1304. In an embodiment, the socket 1307 and the stub 1401 are configured such that the stub 1401 is permitted to slide back and forth in the socket 1307 but is not permitted to spin or move otherwise in the socket 1307. In an embodiment, a cross section of the stub 1401 defines a first rectangle. A cross section of the internal wall of the socket 1307 that receives the stub 1401 defines a second rectangle with a slightly greater dimension than the first rectangle. In an embodiment, one or both of the tip 1402 and the extension rod 1403 are cylindrical when the cross section of the stub 1401 is rectangular. In an embodiment, the bolt 140 further includes on the stub 1401 a neck 1404 that slidably sticks into a slot 1308 on the actuating mechanism 130 to guide or regulate the travel of the bolt 140 when the bolt 140 is being extended or retracted. In an embodiment, the bolt 140 further includes on the stub 1401 a neck 1404 that slidably sticks into a slot 1308 on the second section 1303 of the articulated arm 1304 to guide or regulate the travel of the bolt 140 when the bolt 140 is being extended or retracted. In an embodiment, the tip 1402 will slide into a hole in the strike plate when the actuating mechanism 130 extends the bolt 140 until the neck 1404 arrives at a first end of the slot 1308. In another embodiment, the tip 1402 will slide out of the hole in the strike plate when the actuating mechanism 130 retracts the bolt 140 until the neck 1404 arrives at a second end of the slot 1308. In an embodiment, the tip 1402 has beveled corners to prevent binding. In another embodiment, the tip 1402 has flat sides to prevent rotation. In an embodiment, the neck 1404 fixedly connects a movable section 12312 to the bolt 140. In another embodiment, the movable section 12312 forms a part of the backplate 123 which further includes a pair of fixed sections 12311, 12313. In an embodiment, the movable section 12312 forms a wing that extends perpendicular to an axis of the bolt 140. In another embodiment, the backplate 123 is parallel to the axis of the bolt 140.

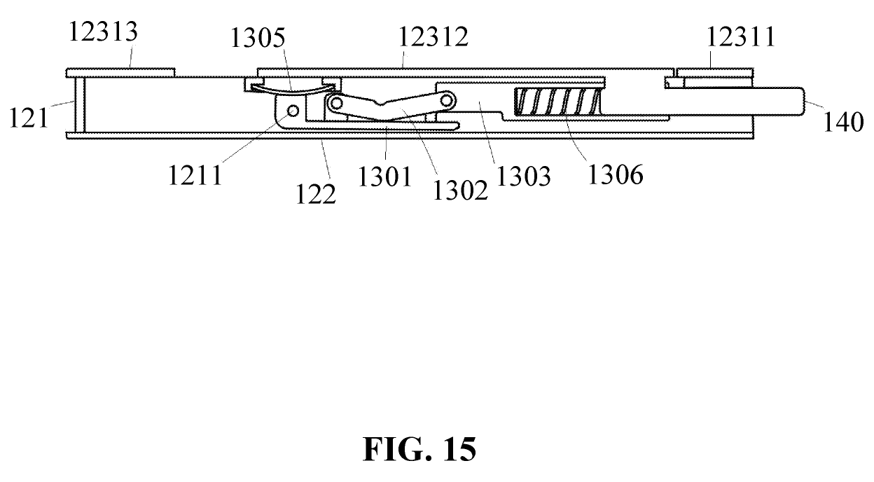

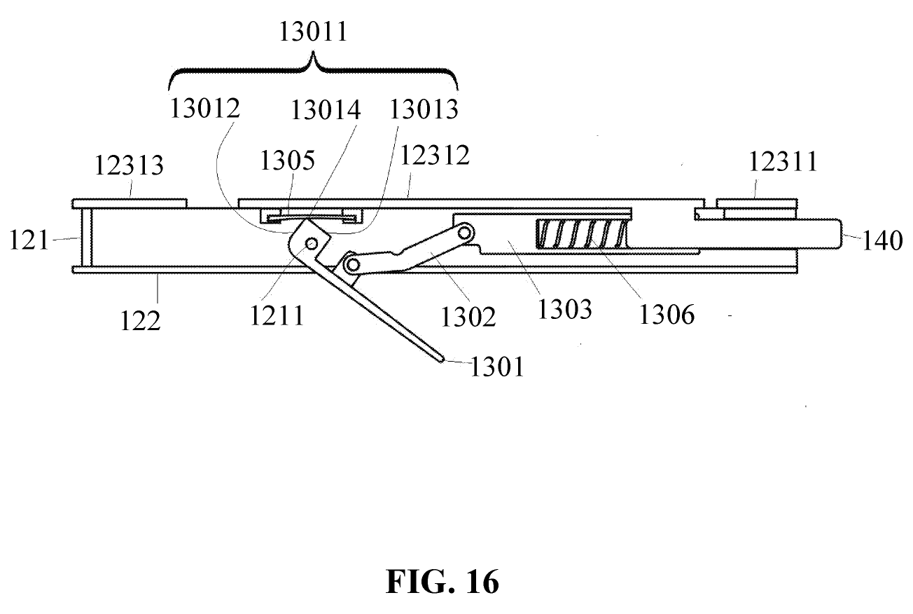

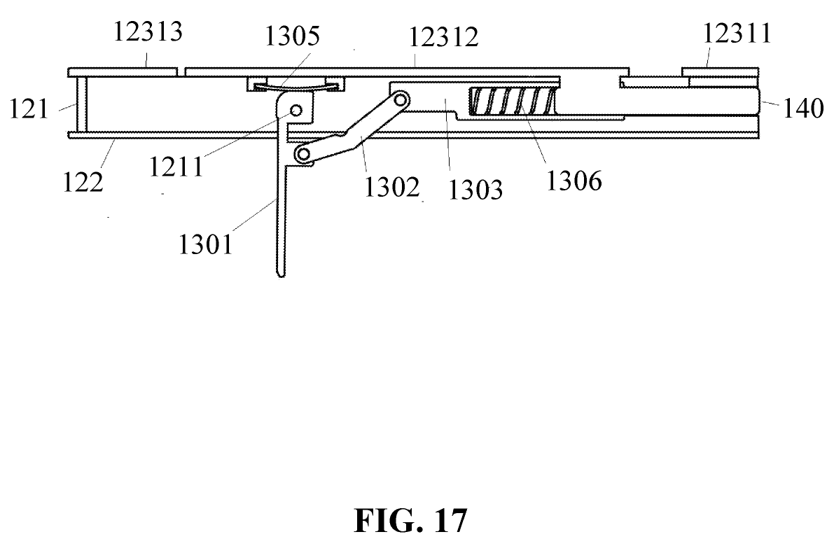

Stay on FIGS. 8-22. The actuating mechanism 130 includes a lever 1301 and an articulated arm 1304. The articulated arm 1304 includes a first section 1302 and a second section 1303 that pivotably joins the first section 1302. The first section 1302 is pivotably connected to the lever 1301 at one end and pivotably connected to the second section 1303 at the other end. In an embodiment, the first section 1302 is angled to pivotably connect the lever 1301 and to pivotably connect the second section 1303. The second section 1303 is pivotably connected to the first section 1302 at one end and slidably connected to the bolt 140 at the other end. The lever 1301, which is configured to pivot around a shaft 1211 fixed on the chassis 121, has a first position (FIGS. 17 & 20) and a second position (FIGS. 15 & 18). A force applied to rotate the lever 1301, which will be transferred to the articulated arm 1304, can slide the second section 1303 back and forth within the main body 120. The bolt 140 will be fully retracted by the articulated arm 1304 when the lever 1301 is manipulated to the first position. The bolt 140 will be fully extended by the articulated arm 1304 when the lever 1301 is manipulated to the second position. In an embodiment, a portion of the lever 1301 which is not at the second position sticks out of the opening 1221 on the faceplate 122 to await a first force. The lever 1301 which is not at the second position can be manipulated to the second position when the portion of the lever 1301 receives the first force. In another embodiment, the lever 1301 at the second position will lie flush with the faceplate 122 to await a second force which is opposite to the first force. The lever 1301 which is not at the first position can be manipulated to the first position when the lever 1301 receives the second force. In an embodiment, the lever 1301 includes a handle or a thumb turn. In another embodiment, the lever 1301 includes a plunger. In an embodiment, the lever 1301 includes a bearing 13011 which is configured to pivot around the shaft 1211. In an embodiment, the bearing 13011 includes a first flat section 13012, a second flat section 13013 and a transition 13014 that connects the first flat section 13012 and the second flat section 13013. In an embodiment, the actuation mechanism 130 further includes a flat spring 1305 which biases the lever 1301 against the shaft 1211. The transition (e.g., a vertex) 13014 is configured such that the lever 1301 will be destabilized by the flat spring 1305 when the bearing 13011 is abutting the flat spring 1305 with the transition 13014. The flat spring 1305 is configured to urge the lever 1301 that is teetering between the first position and the second position (i.e., when the bearing 13011 is abutting the flat spring 1305 with the vertex; FIGS. 16 & 19) to, in response to a gentle nudge upon the lever 1301, rest either at the first position (i.e., when the bearing 13011 is abutting the flat spring 1305 with the first flat section 13012; FIGS. 17 & 20) or the second position (i.e., when the bearing 13011 is abutting the flat spring 1305 with the second flat section 13013; FIGS. 15 & 18). In an embodiment, the second section 1303 includes a slot 1308. The neck 1404 slidably sticks into the slot 1308 to guide or regulate the travel of the bolt 140 when the bolt 140 is being extended or retracted. In an embodiment, the second section 1303 further includes a socket 1307 into which the stub 1401 is slidably plugged into. In another embodiment, the second section 1303 further includes a spring 1306 in the socket 1307 to cushion the slidable connection between the second section 1303 and the bolt 140. In an embodiment, the bolt 140 when being extended can be pushed back into the main body 120 by overcoming the load of the spring 1306 with an external force. In another embodiment, the entire tip 1402 of a fully extended bolt 140, when being pushed with an external force, can recede into the main body 120 by compressing the spring 1306 while the lever 1301 stays at the second position. The bolt 140 being pushed into the main body 120 will bounce back to the extended position once the external force compressing the spring 1306 is removed.

Stay on FIGS. 8-22. The chassis 121 is encased with the faceplate 122 and the backplate 123. In an embodiment, the faceplate 122 is parallel to the backplate 123. In an embodiment, the faceplate 122 includes a first flange 1222 and a second flange 1223. The faceplate 122 is divided by a hypothetical plane which is perpendicular to the faceplate 122 and which passes through an axis of the bolt 140 into the first flange 1222 and the second flange 1223. In an embodiment, the first flange 1222 and the second flange 1223 are fixedly attached to the chassis 121. The first flange 1222 and the second flange 1223 always stay fixed on the chassis 121 when the bolt 140 is moving or not moving. In an embodiment, the first flange 1222 and the second flange 1223 will sit flush with an edge of the door leaf when the flush bolt 200 is properly installed. In another embodiment, the first flange 1222 and the second flange 1223 will sit flush with an edge of the astragal 11 that is mounted on an edge of the door leaf 30. In an embodiment, the faceplate 122 further includes an opening 1221 to allow access to the lever 1301 by a user or the active door leaf 20 that will rotate the lever 1301. In an embodiment, the first flange 1222 and the second flange 1223 are symmetrical with respect to the hypothetical plane. In another embodiment, the faceplate 122 includes a plurality of holes 1224 on both sides of the opening 1221. Screws (not shown) are driven through the plurality of holes 1224, penetrate the astragal 11 and bite into the door leaf 30 to fasten the flush bolt 200 tightly to the astragal 11 and door leaf 30. In an embodiment, the heads of the screws sit flush with an edge of the astragal 11 which is mounted on the door leaf 30 when the flush bolt 200 is properly installed.

Stay on FIGS. 8-22. In an embodiment, the backplate 123 includes a third flange 1231 and a fourth flange 1232. The backplate 123 is divided by a hypothetical plane which is perpendicular to the backplate 123 and which passes through the axis of the bolt 140 into the third flange 1231 and the fourth flange 1232. In an embodiment, the third flange 1231 includes a pair of fixed sections 12311, 12313 and a movable section 12312 that is separate from the pair of fixed sections 12311, 12313. The movable section 12312 is fixedly connected to the bolt 140 at the neck 1404. The pair of fixed sections 12311, 12313, however, are fixedly attached to the chassis 121. The movable section 12312 will slide over the chassis 121 when the bolt 140 is being extended or retracted while the pair of fixed sections 12311,12313 always stay fixed on the chassis 121. In an embodiment, the movable section 12312 is configured to slide between the pair of fixed sections 12311, 12313. In another embodiment, a length of the movable section 12312 is longer, along a direction parallel to an axis of the bolt 140, than the length of any one of the pair of fixed sections 12311, 12313. In an embodiment, a length of the movable section 12312 is longer, along a direction parallel to the axis of the bolt 140, than a combined length of the pair of fixed sections 12311, 12313. The length of the back plate 123, along a direction parallel to an axis of the bolt 140, is A. The combined length of the pair of fixed sections 12311, 12313, along a direction parallel to an axis of the bolt 140, is B. The length of the movable section 12312, along a direction parallel to an axis of the bolt 140, is C. The length of the portion of bolt 140 that sticks out of the main body 120, along a direction parallel to an axis of the bolt 140, is D when the lever 1301 stays at the second position. A distance between the first end of the slot 1308 and the second end of the slot 1308 is L. In an embodiment, (A - B - C) ≥ D. In another embodiment, (A - B - C) ≥ L. In yet another embodiment, L ≥ D. In an embodiment, the movable section 12312 abuts the first one of the pair of fixed sections 12311 but is spaced apart from the second one of the pair of fixed sections 12313 when the lever 1301 stays at the second position. The movable section 12312 abuts the second one of the pair of fixed sections 12313 but is spaced apart from the first one of the pair of fixed sections 12311 when the lever 1301 stays at the first position. In an embodiment, the length of the second one of the pair of fixed sections 12313 is longer, along a direction parallel to an axis of the bolt 140, than the length of the first one of the pair of fixed sections 12311.

Stay on FIGS. 8-22. In an embodiment, the fourth flange 1232 includes a fixed section which is fixedly attached to the chassis 121 but no movable section. The movable section 12312 of the third flange 1231 moves while the bolt 140 is moving. But the fourth flange 1232 which includes exclusively a fixed section and the pair of fixed sections 13311, 12313 of the third flange 1231 always stay fixed to the chassis 121. The length of the fourth flange 1232, along a direction parallel to an axis of the bolt 140, is E. In an embodiment, (E - B - C) ≥ D. In another embodiment, (E - B - C) ≥ L.

Stay on FIGS. 8-22. In an embodiment, the pair of fixed sections 12311, 12313 of the third flange 1231 and the fourth flange 1232 which includes exclusively a fixed section are fixedly embedded into a mortise carved in the astragal 11 such that the pair of fixed sections 12311, 12313 and the fourth flange 1232 sit flush with the interface between the door leaf 30 and the astragal 11 which is mounted on the door leaf 30. In another embodiment, the movable section 12312 of the third flange 1231 is free to slide, when the bolt 140 is moving, with a clearance fit in a passageway defined by a mortise in the astragal 11 and an edge of the door leaf 30 on which the astragal 11 is mounted. In an embodiment, the backplate 123 includes a plurality of holes 1233 on the pair of fixed sections 12311, 12313 of the third flange 1231 and on the four flange 1232. Screws (not shown) are driven through the plurality of holes 1224 on the faceplate 122, penetrate the astragal 11, pass through the plurality of holes 1233 on the backplate 123 and bite into the door leaf 30 to fasten the flush bolt 200 tightly to the astragal 11 and door leaf 30. In an embodiment, the heads of the screws sit flush with an edge of the astragal 11 when the flush bolt 200 is properly installed.

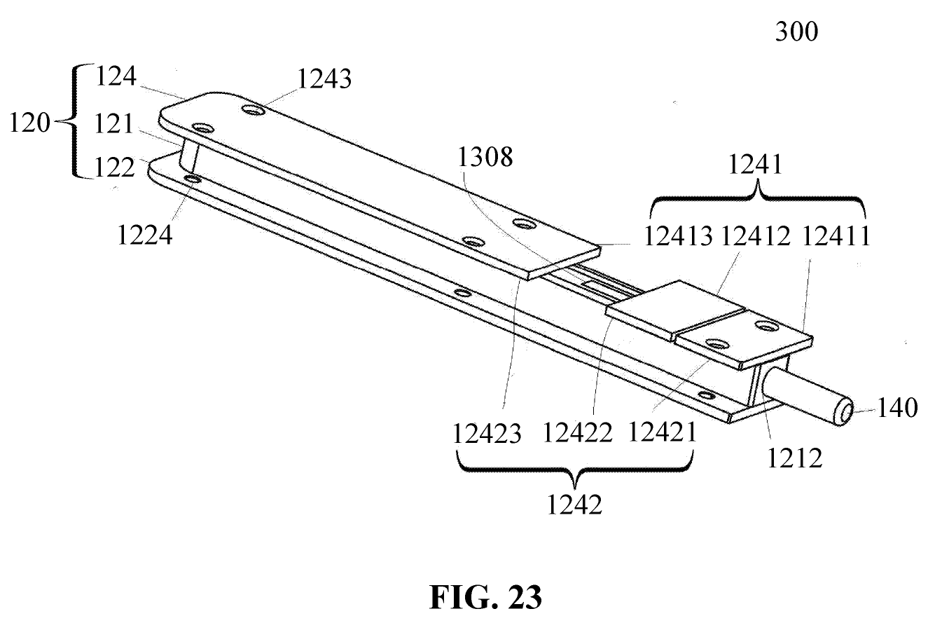

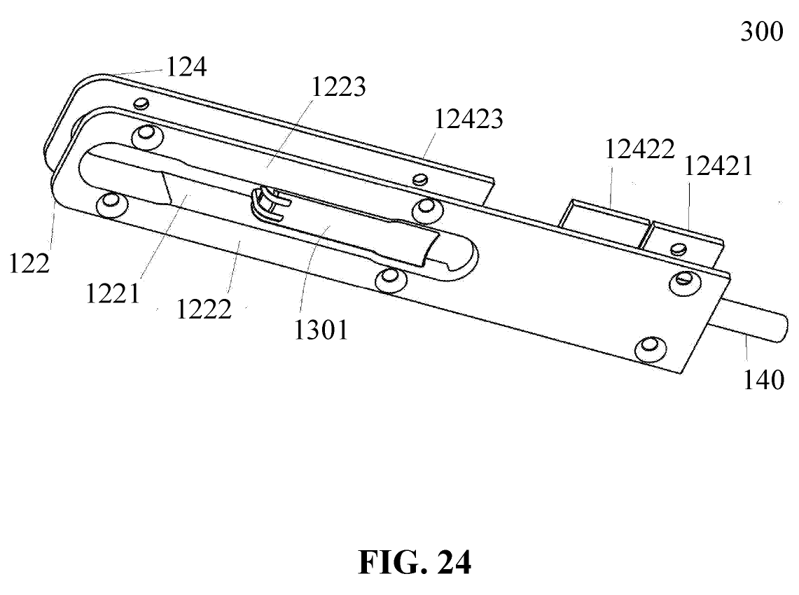

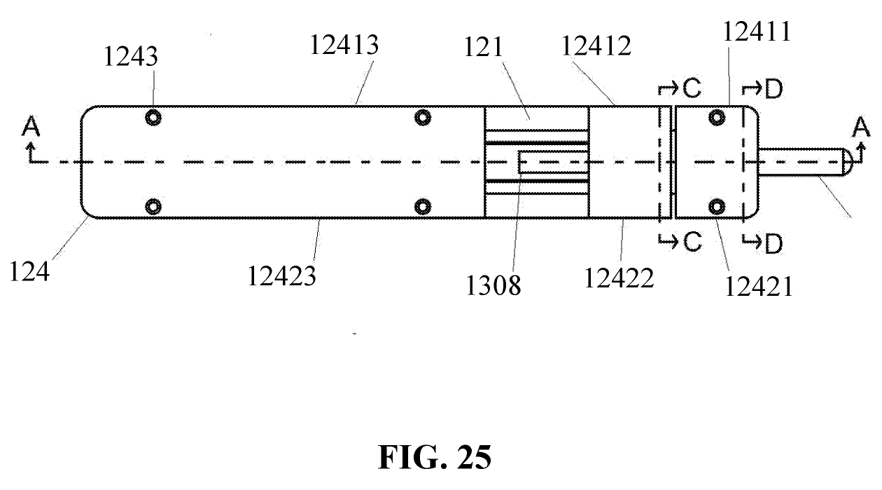

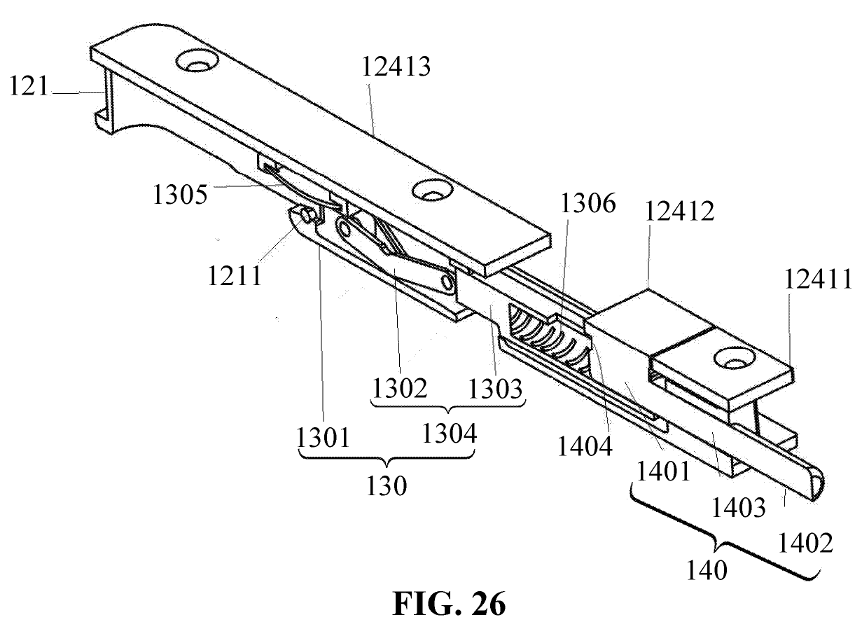

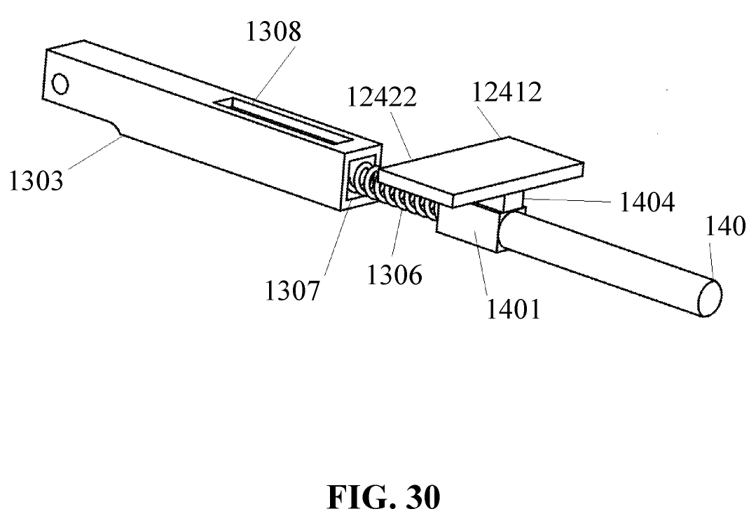

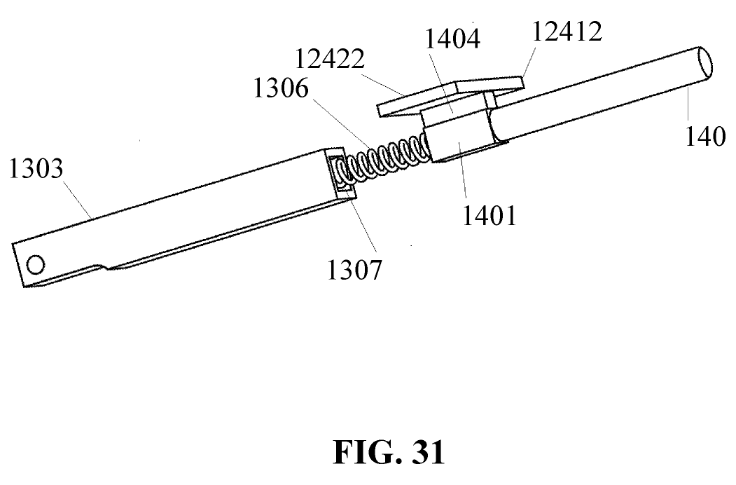

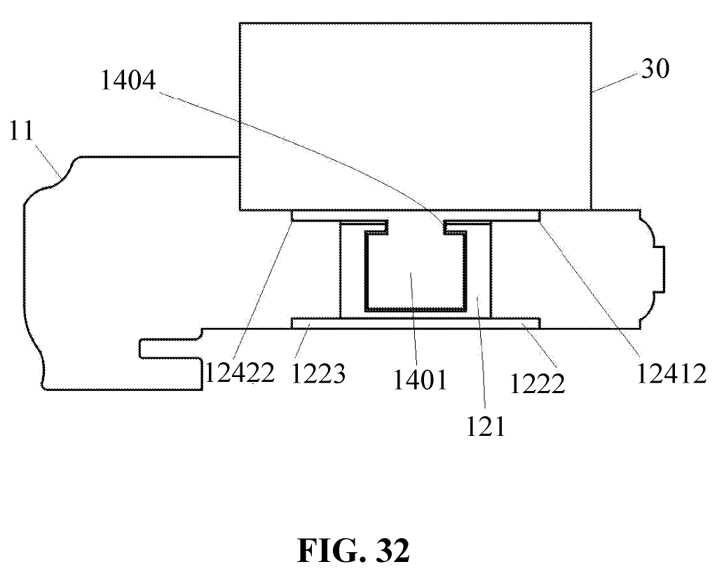

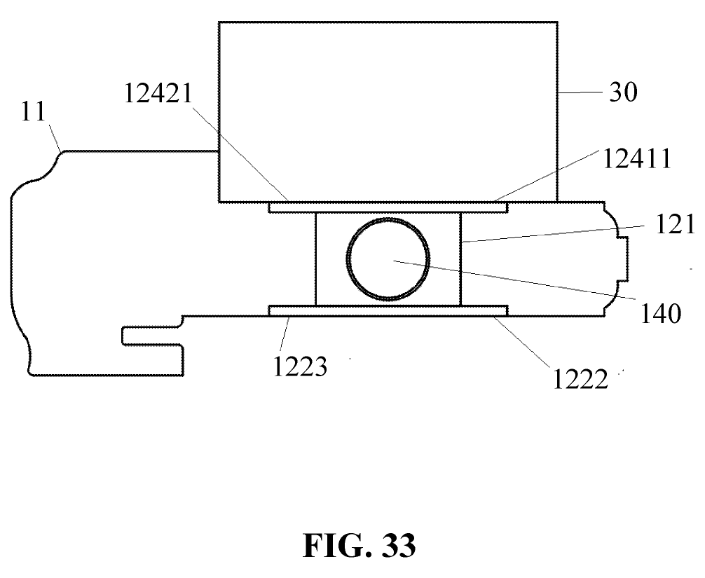

Shifting to FIGS. 23-33 for yet another embodiment of our invention. The flush bolt 300 includes a main body 120, a bolt 140 and an actuating mechanism 130. The main body 120 houses the actuating mechanism 130 and at least a portion of the bolt 140. The actuating mechanism 130 is configured to extend and retract the bolt 140. In an embodiment, the flush bolt 300 is embedded into a mortise in the door leaf to sit flush with an edge of the door leaf. In another embodiment, the flush bolt 300 is embedded into a mortise in the astragal 11 to lie flush with an edge of the astragal 11 which is mounted on an edge of the door leaf 30. In an embodiment, the flush bolt 300 is installed at a top of the door leaf 30. A strike plate fits into a hole in the head jamb or the ceiling for the bolt 140 to slide in and out. In another embodiment, the flush bolt 300 is installed at a bottom of the door leaf 30. A strike plate fits into a hole in the floor or the threshold for the bolt 140 to slide in and out.

Stay on FIGS. 23-33. The main body 120 includes a chassis 121, a faceplate 122 fixed to the chassis 121 and a backplate 124. The chassis 121 provides a framework onto which the actuating mechanism 130 and the bolt 140 are operably assembled. The chassis 121 includes a portal 1212 through which the bolt 140 can protrude from the main body 120 and slide back and forth. In an embodiment, the bolt 140 can withdraw completely into the main body 120 through the portal 1212. The faceplate 122 should sit flush with an edge of the door leaf when the flush bolt 300 is properly installed. In another embodiment, the faceplate 122 should lie flush with an edge of the astragal 11 which is mounted to an edge of the door leaf 30 when the flush bolt 300 is properly installed. The faceplate 122 includes an opening 1221 to allow an external force, which comes from a user or the active door leaf 20, to apply to the actuating mechanism 130. The chassis 121 is sandwiched between the faceplate 122 and the backplate 124. In an embodiment, the faceplate 123 is parallel to the backplate 124. In another embodiment, the faceplate 123 and the backplate 124 are parallel to the axis of the bolt 140.

Stay on FIGS. 23-33. The bolt 140 includes a stub 1401 on one end and a tip 1402 on the other end. In an embodiment, the bolt 140 further includes an extension rod 1403 to interconnect the stub 1401 and the tip 1402. The bolt 140 is connected, with a clearance fit, to the actuating mechanism 130 at the stub 1401. In an embodiment, the stub 1401 is slidably plugged into a socket 1307 on the actuating mechanism 130. In an embodiment, the socket 1307 and the stub 1401 are configured such that the stub 1401 is permitted to slide back and forth in the socket 1307 but is not permitted to spin or move otherwise in the socket 1307. In an embodiment, a cross section of the stub 1401 defines a first rectangle. A cross section of the internal wall of the socket 1307 that receives the stub 1401 defines a second rectangle with a slightly greater dimension than the first rectangle. In an embodiment, one or both of the tip 1402 and the extension rod 1403 are cylindrical when the cross section of the stub 1401 is rectangular. In an embodiment, the bolt 140 further includes on the stub 1401 a neck 1404 that slidably sticks into a slot 1308 on the actuating mechanism 130 to guide or regulate the travel of the bolt 140 when the bolt 140 is being extended or retracted. In an embodiment, the tip 1402 will slide into a hole in the strike plate when the actuating mechanism 130 extends the bolt 140 until the neck 1404 arrives at a first end of the slot 1308. In another embodiment, the tip 1402 will slide out of the hole in the strike plate when the actuating mechanism 130 retracts the bolt 140 until the neck 1404 arrives at a second end of the slot 1308. In an embodiment, the tip 1402 has beveled corners to prevent binding. In another embodiment, the tip 1402 has flat sides to prevent rotation. In an embodiment, the neck 1404 fixedly connects a pair of movable sections 12412, 12422 to the bolt 140. In another embodiment, the pair of movable sections 12412, 12422 forms a part of the backplate 124. In an embodiment, the pair of movable sections 12412, 12422 form a pair of wings that extend perpendicular to an axis of the bolt 140. In another embodiment, the backplate 123 is parallel to the axis of the bolt 140.

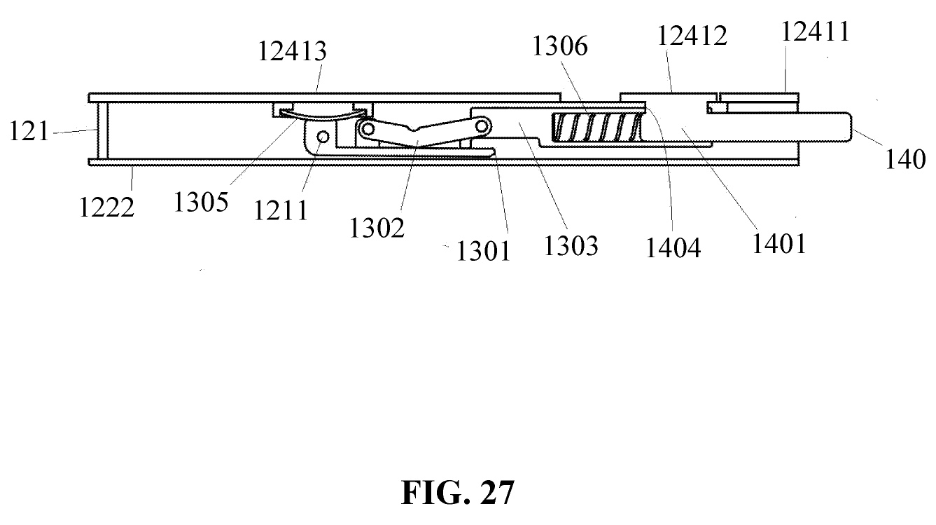

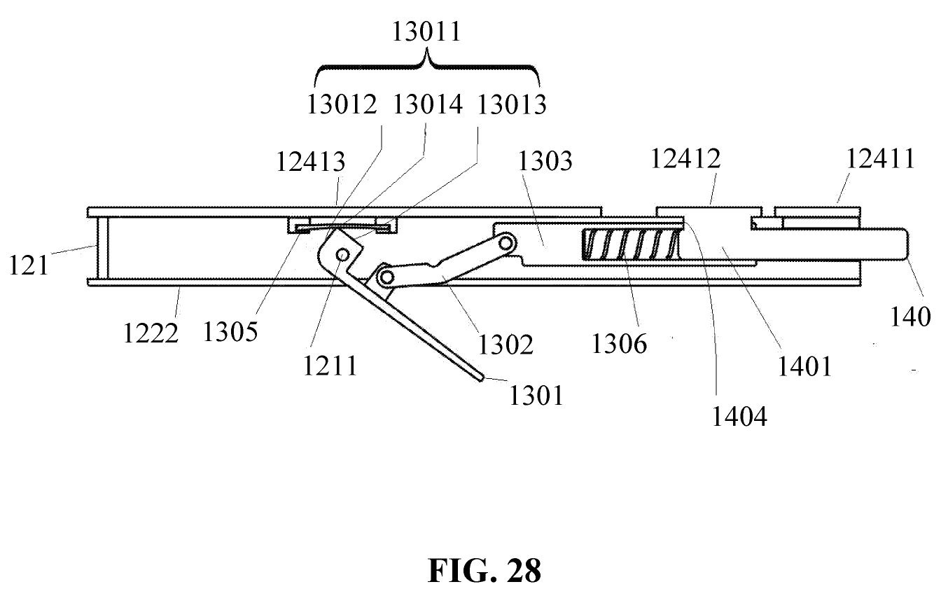

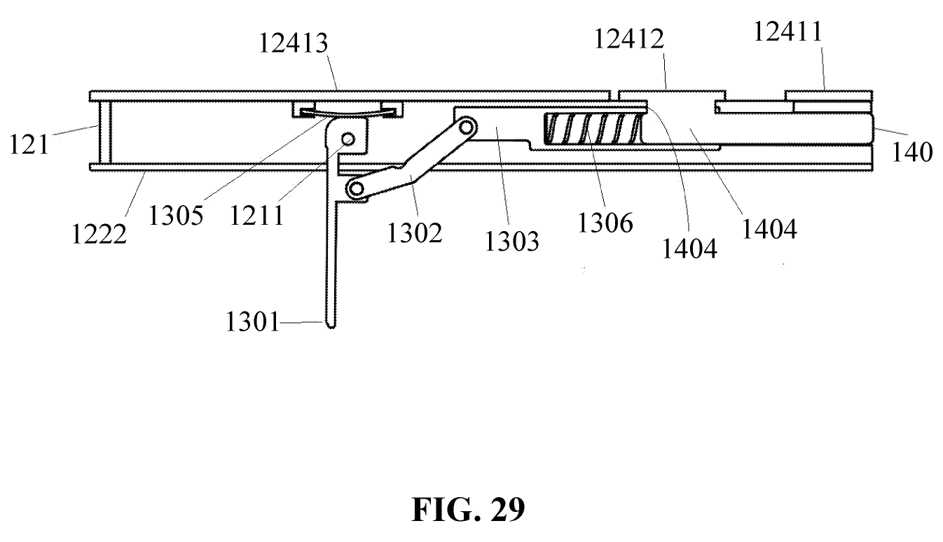

Stay on FIGS. 23-33. The actuating mechanism 130 includes a lever 1301 and an articulated arm 1304. The articulated arm 1304 includes a first section 1302 and a second section 1303 that pivotably joins the first section 1302. The first section 1302 is pivotably connected to the lever 1301 at one end and pivotably connected to the second section 1303 at the other end. In an embodiment, the first section 1302 is angled to pivotably connect the lever 1301 and to pivotably connect the second section 1303. The second section 1303 is pivotably connected to the first section 1302 at one end and slidably connected to the bolt 140 at the other end. The lever 1301, which is configured to pivot around a shaft 1211 fixed on the chassis 121, has a first position (FIG. 29) and a second position (FIG. 27). A force applied to rotate the lever 1301, which will be transferred to the articulated arm 1304, can slide the second section 1303 back and forth within the main body 120. The bolt 140 will be fully retracted by the articulated arm 1304 when the lever 1301 is manipulated to the first position. The bolt 140 will be fully extended by the articulated arm 1304 when the lever 1301 is manipulated to the second position. In an embodiment, a portion of the lever 1301 which is not at the second position sticks out of the opening 1221 on the faceplate 122 to await a first force. The lever 1301 which is not at the second position can be manipulated to the second position when the portion of the lever 1301 receives the first force. In another embodiment, the lever 1301 at the second position will lie flush with the faceplate 122 to await a second force which is opposite to the first force. The lever 1301 which is not at the first position can be manipulated to the first position when the lever 1301 receives the second force. In an embodiment, the lever 1301 includes a handle or a thumb turn. In another embodiment, the lever 1301 includes a plunger. In an embodiment, the lever 1301 includes a bearing 13011 which is configured to pivot around the shaft 1211. In an embodiment, the bearing 13011 includes a first flat section 13012, a second flat section 13013 and a transition 13014 that connects the first flat section 13012 and the second flat section 13013. In an embodiment, the actuation mechanism 130 further includes a flat spring 1305 which biases the lever 1301 against the shaft 1211. The transition (e.g., a vertex) 13014 is configured such that the lever 1301 will be destabilized by the flat spring 1305 when the bearing 13011 is abutting the flat spring 1305 with the transition 13014. The flat spring is configured to urge the lever 1301 that is teetering between the first position and the second position (i.e., when the bearing 13011 is abutting the flat spring 1305 with the vertex; FIG. 28) to, in response to a gentle nudge upon the lever 1301, rest either at the first position (i.e., when the bearing 13011 is abutting the flat spring 1305 with the first flat section 13012; FIG. 29) or the second position (i.e., when the bearing 13011 is abutting the flat spring 1305 with the second flat section 13013; FIG. 27). In an embodiment, the second section 1303 includes a slot 1308. The neck 1404 slidably sticks into the slot 1308 to guide or regulate the travel of the bolt 140 when the bolt 140 is being extended or retracted. In an embodiment, the second section 1303 further includes a socket 1307 into which the stub 1401 is slidably plugged into. In another embodiment, the second section 1303 further includes a spring 1306 in the socket 1307 to cushion the slidable connection between the second section 1303 and the bolt 140. In an embodiment, the bolt 140 when being extended can be pushed back into the main body 120 by overcoming the load of the spring 1306 with an external force. In another embodiment, the entire tip 1402 of a fully extended bolt 140, when being pushed with an external force, can recede into the main body 120 by compressing the spring 1306 while the lever 1301 stays at the second position. The bolt 140 being pushed into the main body 120 will bounce back to the extended position once the external force compressing the spring 1306 is removed.

Stay on FIGS. 23-33. The chassis 121 is encased with the faceplate 122 and the backplate 124. In an embodiment, the faceplate 122 is parallel to the backplate 124. In an embodiment, the faceplate 122 includes a first flange 1222 and a second flange 1223. The faceplate 122 is divided by a hypothetical plane which is perpendicular to the faceplate 122 and which passes through an axis of the bolt 140 into the first flange 1222 and the second flange 1223. In an embodiment, the first flange 1222 and the second flange 1223 are fixedly attached to the chassis 121. The first flange 1222 and the second flange 1223 always stay fixed on the chassis 121 when the bolt 140 is moving or not moving. In an embodiment, the first flange 1222 and the second flange 1223 will sit flush with an edge of the door leaf when the flush bolt 300 is properly installed. In another embodiment, the first flange 1222 and the second flange 1223 will sit flush with an edge of the astragal 11 that is mounted on an edge of the door leaf 30. In an embodiment, the faceplate 122 further includes an opening 1221 to allow access to the lever 1301 by a user or the active door leaf 20 that will rotate the lever 1301. In an embodiment, the first flange 1222 and the second flange 1223 are symmetrical with respect to the hypothetical plane. In another embodiment, the faceplate 122 includes a plurality of holes 1224 on both sides of the opening 1221. Screws (not shown) are driven through the plurality of holes 1224, penetrate the astragal 11 and bite into the door leaf 30 to fasten the flush bolt 300 tightly to the astragal 11 and door leaf 30. In an embodiment, the heads of the screws sit flush with an edge of the astragal 11 which is mounted on the door leaf 30 when the flush bolt 300 is properly installed.

Stay on FIGS. 23-33. In an embodiment, the backplate 124 includes a third flange 1241 and a fourth flange 1242. The backplate 124 is divided by a hypothetical plane which is perpendicular to the backplate 124 and which passes through the axis of the bolt 140 into the third flange 1241 and the fourth flange 1242. In an embodiment, the third flange 1241 includes a first pair of fixed sections 12411, 12413 and a first movable section 12412 that is separate from the first pair of fixed sections 12411, 12413. The first movable section 12412 is fixedly connected to the bolt 140 at the neck 1404. The first pair of fixed sections 12411, 12413, however, are fixedly attached to the chassis 121. The first movable section 12412 will slide over the chassis 121 when the bolt 140 is being extended or retracted while the first pair of fixed sections 12411, 12413 always stay fixed on the chassis 121. In an embodiment, the first movable section 12412 is configured to slide between the first pair of fixed sections 12411, 12413. In another embodiment, a length of the first movable section 12412 is shorter, along a direction parallel to an axis of the bolt 140, than a length of one of the first pair of fixed sections 12411, 12413. In an embodiment, a length of the first movable section 12412 is equal, along a direction parallel to the axis of the bolt 140, to a length of one of the first pair of fixed sections 12411, 12413. The length of the backplate 124, along a direction parallel to an axis of the bolt 140, is A. The combined length of the first pair of fixed sections 12411, 12413, along a direction parallel to an axis of the bolt 140, is B1. The length of the first movable section 12412, along a direction parallel to an axis of the bolt 140, is C1. The length of the portion of the bolt 140 that sticks out of the main body 120, along a direction parallel to an axis of the bolt 140, is D when the lever 1301 stays at the second position. A distance between the first end of the slot 1308 and the second end of the slot 1308 is L. In an embodiment, (A - B1 - C1) ≥ D. In another embodiment, (A - B1 - C1) ≥ L. In yet another embodiment, L ≥ D. In an embodiment, the first movable section 12412 abuts the first one of the first pair of fixed sections 12411 but is spaced apart from the second one of the first pair of fixed sections 12413 when the lever 1301 stays at the second position. The first movable section 12412 abuts the second one of the first pair of fixed sections 12413 but is spaced apart from the first one of the first pair of fixed sections 12411 when the lever 1301 stays at the first position. In an embodiment, the length of the second one of the first pair of fixed sections 12413 is longer, along a direction parallel to an axis of the bolt 140, than the length of the first one of the first pair of fixed sections 12411.

Stay on FIGS. 23-33. In an embodiment, the fourth flange 1242 includes a second pair of fixed sections 12421, 12423 and a second movable section 12422 that is separate from the second pair of fixed sections 12421, 12423. The second movable section 12422 is fixedly connected to the bolt 140 at the neck 1404. The second pair of fixed sections 12421,12423, however, are fixedly attached to the chassis 121. The second movable section 12422 will slide over the chassis 121 when the bolt 140 is being extended or retracted while the second pair of fixed sections 12421, 12423 always stay fixed on the chassis 121. In an embodiment, the second movable section 12422 is configured to slide between the second pair of fixed sections 12421, 12423. In another embodiment, a length of the second movable section 12422 is shorter, along a direction parallel to an axis of the bolt 140, than a length of one of the second pair of fixed sections 12421, 12423. In an embodiment, a length of the second movable section 12422 is equal, along a direction parallel to the axis of the bolt 140, to a length of one of the second pair of fixed sections 12421, 12423. The length of the backplate 124, along a direction parallel to an axis of the bolt 140, is A. The combined length of the second pair of fixed sections 12421, 12423, along a direction parallel to an axis of the bolt 140, is B2. The length of the second movable section 12422, along a direction parallel to an axis of the bolt 140, is C2. The length of the portion of the bolt 140 that sticks out of the main body 120, along a direction parallel to an axis of the bolt 140, is D when the lever 1301 stays at the second position. A distance between the first end of the slot 1308 and the second end of the slot 1308 is L. In an embodiment, (A - B2 - C2) ≥ D. In another embodiment, (A - B2 - C2) ≥ L. In yet another embodiment, L ≥ D. In an embodiment, the second movable section 12422 abuts the first one of the second pair of fixed sections 12421 but is spaced apart from the second one of the second pair of fixed sections 12423 when the lever 1301 stays at the second position. The second movable section 12422 abuts the second one of the second pair of fixed sections 12423 but is spaced apart from the first one of the second pair of fixed sections 12421 when the lever 1301 stays at the first position. In an embodiment, the length of the second one of the second pair of fixed sections 12423 is longer, along a direction parallel to an axis of the bolt 140, than the length of the first one of the second pair of fixed sections 12421.

Stay on FIGS. 23-33. In an embodiment, the first pair of fixed sections 12411, 12413 and the second pair of fixed sections 12421, 12423 are fixedly embedded into a mortise carved in the astragal 11 such that the first pair of fixed sections 12411, 12413 and the second pair of fixed sections 12421, 12423 sit flush with the interface between the door leaf 30 and the astragal 11 which is mounted on the door leaf 30. In another embodiment, the first movable section 12412 and the second movable section 12422 are free to slide, when the bolt 140 is moving, with a clearance fit in a passageway defined by a mortise in the astragal 11 and an edge of the door leaf 30 on which the astragal 11 is mounted. In an embodiment, the backplate 124 includes a plurality of holes 1243 on the first pair of fixed sections 12411, 12413 and on the second pair of fixed sections 12421, 12423. Screws (not shown) are driven through the plurality of holes 1224 on the faceplate 122, penetrate the astragal 11, pass through the plurality of holes 1243 on the backplate 124 and bite into the door leaf 30 to fasten the flush bolt 300 tightly to the astragal 11 and door leaf 30. In an embodiment, the heads of the screws sit flush with an edge of the astragal 11 when the flush bolt 300 is properly installed.

Stay on FIGS. 23-33. In an embodiment, the third flange 1241 and the fourth flange 1242 are symmetric with respect to the hypothetical plane that divides the backplate 124. The first movable section 12412 and the second movable section 12422 move together with the bolt 140 when the bolt 140 is moving while the first pair of fixed sections 12411, 12413 and the second pair of fixed sections 12421, 12423 always stay fixed on the chassis 121. In another embodiment, the third flange 1241 and the fourth flange 1242 are not symmetric.

Having described at least one of the embodiments of the claimed invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents. Specifically, one or more limitations recited throughout the specification can be combined in any level of details to the extent they are described to improve the flush bolt.

What is claimed is:

1. A flush bolt configured to be installed on a door leaf with an astragal, comprising:
a main body;
a bolt; and
an actuating mechanism, wherein:
the astragal is mounted to an edge of the door leaf;
the main body houses the actuating mechanism and at least a portion of the bolt;
the actuating mechanism is configured to extend and retract the bolt;
the main body includes a chassis, a faceplate fixed to the chassis and a backplate;
the faceplate is configured to lie flush with an edge of the astragal;
the chassis provides a framework onto which the actuating mechanism and the bolt are operably assembled;
the chassis includes a portal through which the bolt can protrude from the main body and slide back and forth;
the chassis, which is sandwiched between the faceplate and the backplate, is encased with the faceplate and the backplate;
the bolt includes a stub on one end and a tip on an other end;
the actuating mechanism includes a lever and an articulated arm;
the articulated arm includes a first section and a second section that pivotably joins the first section;
the stub is slidably plugged into a socket in the second section of the articulated arm;
the socket and the stub are configured such that the stub is permitted to slide back and forth in the socket but is not permitted to spin or move otherwise in the socket;
the bolt further includes on the stub a neck that slidably sticks into a slot on the second section of the articulated arm to guide a travel of the bolt when the bolt is being extended or retracted;
the first section is pivotably connected to the lever at one end and pivotably connected to the second section at an other end;
the second section is pivotably connected to the first section at one end and slidably connected to the bolt at an other end;
the lever, which is configured to pivot around a shaft fixed on the chassis, has a first position and a second position;
a force applied to rotate the lever, which is transferred to the articulated arm, can slide the second section back and forth within the main body;
the bolt is configured to be fully retracted by the articulated arm when the lever is manipulated to the first position;
the bolt is configured to be fully extended by the articulated arm when the lever is manipulated to the second position;
the faceplate is divided by a hypothetical plane which is perpendicular to the faceplate and which passes through an axis of the bolt into a first flange and a second flange;
the first flange and the second flange are fixedly attached to the chassis;
the first flange and the second flange always stay fixed on the chassis when the bolt is moving;
the faceplate includes an opening to allow an external force to be applied to the lever;
the backplate is divided by a hypothetical plane which is perpendicular to the backplate and which passes through an axis of the bolt into a third flange and a fourth flange;
the third flange includes a first pair of fixed sections and a first movable section that is separate from the first pair of fixed sections;
the first movable section is fixedly connected to the bolt at the neck;
the first pair of fixed sections are fixedly attached to the chassis;
the first movable section is configured to slide over the chassis when the bolt is being extended or retracted while the first pair of fixed sections always stay fixed on the chassis;
a length of the backplate, along a direction parallel to an axis of the bolt, is A;
a combined length of the first pair of fixed sections, along a direction parallel to an axis of the bolt, is B1;
a length of the first movable section, along a direction parallel to an axis of the bolt, is C1;
a length of a portion of the bolt that sticks out of the main body, along a direction parallel to an axis of the bolt, is D when the lever stays at the second position;
the tip is configured to slide into a hole to lock the door leaf when the actuating mechanism extends the bolt until the neck arrives at a first end of the slot;
the tip is configured to slide out of the hole to unlock the door leaf when the actuating mechanism retracts the bolt until the neck arrives at a second end of the slot;
a distance between the first end of the slot and the second end of the slot is L;
(A - B1 - C1) ≥ L; and
1L ≥ D.

2. The flush bolt in claim 1, wherein:
the fourth flange includes a fixed section which is fixedly attached to the chassis but no movable section;
the fourth flange always stay fixed to the chassis;
a length of the fourth flange along a direction parallel to an axis of the bolt is E; and
(E - B1 - C1) ≥ L.

3. The flush bolt in claim 1, wherein:
the fourth flange includes a second pair of fixed sections and a second movable section that is separate from the second pair of fixed sections;
the second movable section is fixedly connected to the bolt at the neck;
the second pair of fixed sections are fixedly attached to the chassis;
the second movable section is configured to slide over the chassis when the bolt is being extended or retracted while the second pair of fixed sections always stay fixed on the chassis;
a combined length of the second pair of fixed sections, along a direction parallel to an axis of the bolt, is B2;
a length of the second movable section, along a direction parallel to an axis of the bolt, is C2; and
(A - B2 - C2) ≥ L.

4. The flush bolt in claim 3, wherein:
the third flange and the fourth flange are symmetric with respect to the hypothetical plane that divides the backplate; and
the first movable section and the second movable section move together with the bolt when the bolt is moving while the first pair of fixed sections and the second pair of fixed sections always stay fixed on the chassis.

5. The flush bolt in claim 1, wherein: a length of the first movable section is longer, along a direction parallel to an axis of the bolt, than a length of any one of the first pair of fixed sections.

6. The flush bolt in claim 1, wherein:
the second section further includes a spring in the socket to cushion a slidable connection between the second section and the bolt;
the bolt when being extended can be pushed back into the main body by overcoming a load of the spring with an external force;
an entire tip of a fully extended bolt, when being pushed with an external force, can recede into the main body by compressing the spring while the lever is staying at the second position; and
the bolt being pushed into the main body is configured to bounce back to an extended position when the bolt is released.

7. The flush bolt in claim 3, wherein:
the first movable section is configured to slide between the first pair of fixed sections;
the first movable section abuts a first one of the first pair of fixed sections but is spaced apart from a second one of the first pair of fixed sections when the lever stays at the second position;
the first movable section abuts the second one of the first pair of fixed sections but is spaced apart from the first one of the first pair of fixed sections when the lever stays at the first position;
the second movable section is configured to slide between the second pair of fixed sections;
the second movable section abuts a first one of the second pair of fixed sections but is spaced apart from a second one of the second pair of fixed sections when the lever stays at the second position; and
the second movable section abuts the second one of the second pair of fixed sections but is spaced apart from the first one of the second pair of fixed sections when the lever stays at the first position.

8. The flush bolt in claim 1, wherein:
the faceplate and the backplate are parallel to an axis of the bolt;
the lever includes a bearing which is configured to pivot around the shaft;
the bearing includes a first flat section, a second flat section and a transition that connects the first flat section and the second flat section;
the actuation mechanism further includes a flat spring which biases the lever against the shaft;
the transition is configured such that the lever will be destabilized by the flat spring when the bearing is abutting the flat spring with the transition; and
the flat spring is configured to urge the lever that is teetering between the first position and the second position to rest either at the first position or at the second position.

9. The flush bolt in claim 1, wherein: the bolt further includes an extension rod to interconnect the stub and the tip.

10. The flush bolt in claim 1, wherein:
a cross section of the stub defines a first rectangle; and
a cross section of an internal wall of the socket that receives the stub defines a second rectangle with a greater dimension than the first rectangle.

11. The flush bolt in claim 1, wherein:
one or both of the tip and the extension rod are cylindrical; and
a cross section of the stub is rectangular.

12. The flush bolt in claim 3, wherein:
a length of the first movable section is shorter, along a direction parallel to an axis of the bolt, than a length of one of the first pair of fixed sections; and
a length of the second movable section is shorter, along a direction parallel to an axis of the bolt, than a length of one of the second pair of fixed sections.

13. The flush bolt in claim 1, wherein: a length of the first movable section is longer, along a direction parallel to an axis of the bolt, than a combined length of the first pair of fixed sections.

14. The flush bolt in claim 3, wherein: the first movable section and the second movable section form a pair of wings that extend perpendicular to an axis of the bolt.

15. The flush bolt in claim 1, wherein: the first section of the articulated arm is angled to pivotably connect the lever and to pivotably connect the second section of the articulated arm.

16. The flush bolt in claim 2, wherein:
the first flange and the second flange are configured to lie flush with an edge of the astragal; and
the first pair of fixed sections and the fourth flange are configured to be fixedly embedded into a mortise carved in the astragal such that the first pair of fixed sections and the fourth flange sit flush with an interface between the door leaf and the astragal.

17. The flush bolt in claim 16, wherein:
the faceplate includes a plurality of holes on both sides of the opening;
the backplate includes a plurality of holes on the first the pair of fixed sections and on the four flange;
the flush bolt is configured to allow screws to:
be driven through the plurality of holes on the faceplate;
penetrate the astragal;
pass through the plurality of holes on the backplate; and
bite into the door leaf for the flush bolt to attach tightly to the astragal and door leaf;
the flush bolt is configured to allow heads of the screws to sit flush with an edge of the astragal; and
the first movable section is configured to slide, when the bolt is moving, with a clearance fit in a passageway defined by a mortise in the astragal and an edge of the door leaf.

18. The flush bolt in claim 3, wherein:
the first flange and the second flange are configured to lie flush with an edge of the astragal; and
the first pair of fixed sections and the second pair of fixed sections are configured to be fixedly embedded into a mortise carved in the astragal such that the first pair of fixed sections and the second pair of fixed sections sit flush with an interface between the door leaf and the astragal.

19. The flush bolt in claim 18, wherein:
the faceplate includes a plurality of holes on both sides of the opening;
the backplate includes a plurality of holes on the first pair of fixed sections and on the second pair of fixed sections;
the flush bolt is configured to allow screws to:
be driven through the plurality of holes on the faceplate;
penetrate the astragal;
pass through the plurality of holes on the backplate; and
bite into the door leaf for the flush bolt to attach tightly to the astragal and door leaf;
the flush bolt is configured to allow heads of the screws to sit flush with an edge of the astragal; and
the first movable section and the second movable section are configured to slide, when the bolt is moving, with a clearance fit in a passageway defined by a mortise in the astragal and an edge of the door leaf.

20. The flush bolt in claim 1, wherein:
a portion of the lever which is not at the second position sticks out of the opening on the faceplate to await a first force;
the lever which is not at the second position can be manipulated to the second position when the portion of the lever receives the first force;
the lever at the second position is configured to lie flush with the faceplate to await a second force which is opposite to the first force; and
the lever which is not at the first position can be manipulated to the first position when the lever receives the second force.
